(19) United States
(12) Patent Application Publication
(10) Pub. No.: US 2005/0271207 A1
(43) Pub. Date: Dec. 8, 2005

(54) Method and system for chaotic digital signature, encryption, and authentication

(76) Inventor: Helmut Frey, Hamburg (DE)

Correspondence Address: Xavety Corporation, 20 Whiley Road, Groton, MA, 01450-2206, US

(21) Appl. No.: 11/029,253

(22) Filed: Dec. 31, 2004

Related U.S. Application Data
(60) Provisional application No. 60/577,452, filed on Jun. 5, 2004.

(51) Int. Cl. H04L 9/00

(52) U.S. Cl. 380/263

(57) ABSTRACT

The method and system for chaotic digital signature, encryption, and authentication using a chaos generator, which operates in the domain of polynomial integer numbers of arbitrary magnitude.

### TECHNICAL FIELD

This present invention relates generally to a method and system for chaotic digital signature, encryption, and authentication by means of a chaos generator based on extended polynomial integer number arithmetic.

### BACKGROUND

With increasing use of network technologies like Internet and intranet, requirements to ensure security of digital data access and transfer increases as well. This is true for business transactions as well as for private data exchanges of any kind. In data security, it is useful to differentiate between the following features: User authentication, document signature, and data encryption.

Authentication means, that only the information requesting entity (the “client”), gets access to said requested information, which got the permission by the information owning entity (the “server”). The client may be a person, an enterprise, an organization, or also a machine, the server may also be a person, an enterprise, an organization, or also a machine, etc. The client has to authenticate itself to the server before getting access to some service (data, information, network access, etc.) provided by the server for certain clients only. This authentication must be secured in such a way, that the server is able to identify the sender of the request as the permitted client, which the sender pretends to be.

Signature means that the receiver of a document is able to identify definitely the sender of the document as the permitted entity, which the sender pretends to be by its digital signature appended to the document. Further on, it must be guaranteed, that the document has not been modified in any way after it was signed, neither by the sender nor by anybody else during its transfer.

Encryption means the transformation of data in such a way, that the resulting data sequence (which is called “cipher text” in the following) gives no information of its original, and that the only senseful decryption can be performed by that receiver, which got the permission by the sender to do so. It must be guaranteed, that any third party has no chance at all by no means to restore the original data from the cipher text.

A lot of efforts has been done to fulfill the requirements of these three features described above. One of the most popular methods is the so-called asymmetric key encryption, which is based on a private and public key pair. Such asymmetric public key methods were realized in the mid 1970s by Diffie and Hellmann, and later on by Rivest, Shamir and Adleman in their RSA-algorithm, and also e.g. in the ElGamal algorithm. An other most popular method is the symmetric key method, like e.g. realized in IDEA, Blowfish, and DES, which in October 2000 was exchanged with the AES (Advanced Encryption Standard, based on the Rijndael algorithm) by NIST (National Institute of Standards and Technology, U.S. Department of Commerce). A description of the different methods may e.g. be found in “Cryptography and Network Security: Principles and Practice” by William Stallings, Prentice Hall, New Jersey, 2003, 3^{rd} Edition.

All these systems suffer a common disadvantage: security depends to a great extend on the length of the generated keys due to the deterministic nature (mostly but not always based on the arithmetic product of rather big primes) of their generation algorithms. The longer the key the longer the calculation time for decryption and the shorter the key the higher the probability and the risk to crack it. Thus, security is just always a race between useable key length and available computer power. As an example, DES for a long time was considered to be absolutely secure when it was cracked a few years ago. DES was replaced with AES, and AES will most likely be replaced with a further advanced encryption standard developed in future times.

More secure algorithms are based on non-deterministic, chaotic systems and their development started together with the increasing interest and knowledge of chaotic systems in the mid 1980s. Such chaotic systems arise from quite simple but highly non-linear mathematical functions, which are applied, recursively in that the resulting functional value from a starting parameter value is feed back into the function as the new parameter value. Chaotic behavior of such functions is achieved, when the resulting functional value never converges against an attractor (which can be a fix point or an ensemble of fix points) even when the number of feed-backs (iteration steps) tends to infinity. An introduction to such chaotic systems is given e.g. in “Chaos. Making of new science” by James Gleick, Viking Pinguin, New York, 1987. Due to their relative simplicity, two of the most investigated dynamical and chaotic systems are the Logistic Equation (chaotic bifurcation) and the Lorenz Equations (chaotic Lorenz attractor). The present invention refers to the Logistic equation as one example but is not restricted to the Logistic Equation.

### RELATED ART

The Logistic Equation, which in its iterative form is given by
xₙ₊₁=r·xₙ(1−xₙ); xₙ∈ |0,1|∀n ∈ {0,1, . . . , ∞}; 0≦r≦4 (1)
is the basis of the example standing in for the here disclosed invention. One of the first applied chaos generators based on the Logistic Equation and computing in the floating-point domain is described in U.S. Pat. No. 5,048,086 by Bianco. Bianco was using the factor r as the private and secret key, x₀ as a “preamble”. Every iteration result was reflected on the bits 0 and 1 by an appropriate filter function, thus yielding the bit stream of the cipher for either bit-to-bit or block wise encryption. Another chaos generator implementing the Logistic Equation for authentication and signature is described in the European Patent Application EP 0 940 675 by Occhipinti and later identically in U.S. Pat. No. 6,647,493. Almost the same authors extended the application of this chaos generator (the floating point algorithm of the Logistic Equation) to chaotic encryption together with an additional scrambler/unscrambler in European Patent Application EP 1 179 912 by Di Bernardo.

In opposite to the present invention the above-described methods imply disadvantages in respect to security:

1) As to using factor r in equation (1) as the secret and private key.

a) This may produce non-unique and highly deterministic sequences instead of non-deterministic and chaotic ones. In general, chaotic behavior in equation (1) is achieved only within the range
3.58≦r≦4 (2)
but even within this range there exist so called “islands of order” where the system is determined by well defined attractors instead of by chaotic divergence (Peitgen, H.-O., Jürgens, H., Saupe, D. “Chaos and Fractals—New Frontiers of Science” Springer, N.Y., 1992). For example in the range 3.829<r<3.842 exists a 3-cycle attractor where the system converges quickly against a 3-cylce attractor and this independent on the starting value x₀. That means, the system is here well deterministically defined on the one hand and yields same results for a certain range of keys on the other hand. Within the chaotic r-range given by equation (2), unfortunately, there exist an infinite number of such “islands of order” with any arbitrary and unknown n-cycle attractors due to the self-similar fractal system structure. Hence, the probability to get trapped in any of these n-cycle attractors is quite high when using r as the private encryption key.

b) The number of different keys is limited and depends on the machine used for encryption. Considering the case that a 64-bit machine internally calculate with 15 significant decimal digits after the decimal point yields that the number of different keys is limited to 4×10¹⁵−3.58×10¹⁵=4.2×10¹⁴, and a 32-bit machine with 6 significant decimal digits after the decimal point is limited to 4×10⁶−3.58×10⁶=4.2×10⁵ different keys. Nowadays, the latter one does not resist a brute force attack (this is an attack which tries to find an encryption key by the method of trial and error) already. The first one may also not resist in some near times.

c) Using factor r as the private key binds said key to one certain chaos generator, namely to the Logistic Equation. If for any reason the key owning entity wants to make use of another chaos generator, like e.g. the Lorenz Equations or any Julia set, etc, then all the keys issued by this entity are invalid. Thus, said entity would have to issue new keys to all clients, or this entity would have to undertake large efforts in order to fit all the issued keys to the new needs. When thinking of hardware fixed issued keys, like e.g. realized in smart cards, then withdrawing all these issued keys due to a system change seems not desirable.

2) As to calculating the Logistic Equation by the means of floating point operations.

a) Any calculated cipher as result of the chaotic generator computations depends on the machine (CPU, hard coded IC, etc) and/or on the software compiler (C, C++, Fortran, Java, etc.) because the calculation is highly dependent on the internal number representation of the computing system. For example, the simple arithmetic product 0.00001×0.00001 yields the exact number 0 (zero) on a 32-bit platform due to the machine internal truncation error. On a 64-bit platform, however, the identical calculation yields the number 0.0000000001. Although the different results of a multiplying floating point operation affect mostly the last significant digit, the resulting number after some little iteration will differ to a great extent due to the high sensitivity of the chaotic system on even the smallest changes. This implies that any use of the chaos generator requires identical platforms in order to allow any definite result comparison. The use for authentication, signature, and encryption, however, requires definitely platform independency.

b) The solution domain of the considered system is too restricted. The solution interval of the Logistic Equation (equation (1)) is the interval [0, 1]. Thus, on a 64-bit machine with 15 significant decimal digits behind the decimal point, the solution domain consists of 1×10¹⁵ different numbers only. Thus, independent of the starting value, the factor r, and the number of iterations performed, the result is definitely one of these 1×10¹⁵ different numbers. This seems to yield a sufficient number of variations with respect to a brute force attack, however, this restriction implies an other not so obvious but probable danger: to get trapped in an n-cycle attractor due to the machine immanent truncation errors.

c) Following the trend in the development of computer technology, it is obvious that processor clock speed increases by far more quickly than the number of bytes for the machine internal representation of numbers. Thus, the possibility of brute force attacks will also increase more quickly than the capacity to prevent them when restricting the computations on machine internal accuracy.

3) As to sending the starting value x₀ and the number of iterations p to be performed to a client and receiving the result (=“RES”) of the chaotic computation.

a) Considering the arguments under 1) and 2) it is not guaranteed that only one single value of factor r yields the result RES.

b) Due to the fact that factor r is the secret private key and at the same time is part of the calculation algorithm itself and considering the arguments under 1) and 2), a brute force attack is most probably possible in the near future. Getting knowledge of the triple (x₀, p, RES) for each calculation, factor r is the only remaining unknown system parameter.

Okutomi describes a further development of the Logistic Equation chaos generator in the US patent application Publication 2003/0091190, where all the chaos generator computations are performed with platform internal integer arithmetic, thus improving the above-described system in that all the computations are definitely platform independent. Since, however, it is required that an integer multiplication must not exceed the integer space, the numbers for signed integers on a 32-bit platform are restricted to the square root of 2³¹-1, that is to 2¹⁵ which is 32768 in the decimal system. This is quite a rough limitation and even more restrictive than in the floating point domain. To overcome this problem, a huge effort was made by Okutomi by the means of spited mapping functions and spited solution domains and their interaction in order to maintain the characteristic Lyapunov Exponent shape of the Logistic Equation. Also a more complex handling of the system parameters is needed out of the same reason. Besides the advantage of the platform independency, however, there is no evidence of further improvement with respect to the above-described problems.

The present invention is neither restricted nor determined by any of these problems described above and furthermore is easily scalable to any future needs and any technological state of the art.

Other methods considered as secure and widely applied are RSA, ElGamal, AES, and DSS.

a) RSA is an asymmetric encryption technique developed in 1977 by and named after Ronald L. Rivest, Adi Shamir and Leonard Adleman (U.S. Pat. No. 4,405,829 by Rivest et al.). RSA is based on the so-called discrete function problem, by using mathematical functions, which are difficult to reverse. In particular, RSA is based on the generation of three big prime numbers and their product, and on modulo arithmetic. Security is achieved by the difficulty to reconstruct the primes from their product by factoring and therefore depends mainly on the magnitude of the prime numbers (the higher the magnitude the safer the method). This is known as the so-called key-length, which actually is 128 bit in common communication techniques like Secure Socket Layer (SSL), and up to 4096 bit in special encryption techniques like Pretty Good Privacy (PGP) and GNU Privacy Guard (GnuPG), both among others based on the RSA algorithm. Security always depends on the capability of the individual computer power to perform suitable and efficient factoring techniques. Because security depends on the bit-length handled by the computer there is a permanent need to increase the bit-length with increasing computer power. The smaller the bit length used, the higher the chance to break the encryption. Since computer power proved to grow exponentially the need of using bigger and bigger prime numbers increases severely. In some future time, the primes will have to be chosen so big that the respective encryption algorithm will be far beyond a real time process.

b) Like RSA, the asymmetric ElGamal method is also based on the so-called discrete function problem, but in contrast to the RSA based methods uses exponential functions instead of prime numbers. It is a further development of the so-called Diffie-Hellman method (U.S. Pat. No. 4,200,770 by Hellmann et al.). Taher Elgamal published in 1985 his method (ElGamal, T., “A public key cryptosystem and a signature scheme based on discrete logarithms, ” IEEE Transactions on Information Theory, Vol.IT-31, No.4, pp. 469-472, 1985), which is based on the exponentiation of random integer numbers and modulo arithmetic with a prime as the modulo number. Exponentiation produces even lager numbers than prime multiplication. Thus the same problem as stated above occurs even more severely for this method. A further disadvantage is that the encrypted text becomes twice the size of the original text and is therefore mainly used to establish common keys and not to encrypt messages.

Both, the ElGamal and RSA methods cannot be considered as secure in general nowadays (Boneh, D. et al., “Why Textbook ElGamal and RSA Encryption are Insecure”, Proceedings AsiaCrypt '00, Lecture Notes in Computer Science, Vol. 1976, Springer-Verlag, pp. 30-44, 2000). On Dec. 3, 2003, a team (J. Franke and T. Kleinjung) at the German Federal Agency for Information Technology Security, BSI, won 10 000 $ for breaking RSA-576. Further on, As shown already in 1996 by MIT Professor Shor (Shor, P. W., “Polynomial-time algorithms for prime factorization and discrete logarithms on a quantum computer”, SIAM J. Computing 26, pp. 1484-1509, 1997) so-called quantum computers can perform prime number factoring and finding discrete logarithms with just the same afford as needed for the prime number multiplication of the RSA or the exponentiation of the ElGamel method. Thus, both methods are breakable in principle and just a question of available computer hardware, suitable factoring algorithms, and available computing time.

c) The Data Encryption Standard (DES) was developed in 1974 and nominated as NIST Standard. Individual bit groups are permutated or replaced in any byte. Encoding and decoding are performed using the same key (symmetrical method). Because the DES method had been cracked, the Advanced Encryption Standard AES (also known as the Rijndael-algorithm) was developed and implemented in 2001 by NIST (National Institute of Standards and Technology) to replace the DES method (National Institute of Standards and Technology, “Announcing the ADVANCED ENCRYPTION STANDARD (AES)”, Federal Information Processing Standards Publication 197, Nov. 26, 2001). AES is in principle based on the same algebraic methods as DES but using longer key length (128 bit or higher instead of 64). The permutation and replacement method of bits is hence more complicated and takes more computer power and time. It is a matter of time when AES will get cracked (Mackenzie, D., “A Game of Chance”, New Scientist (Jun. 7, 2003) Vol. 178, No. 2398, P. 36, 2003). The security and lifespan of the AES method is still a matter of intense discussion by the security community: Optimistic estimates date 30 years; pessimistic ones date only 5 years

d) The latest revision of the Digital Signature Standard by NIST was published in January 2000 (National Institute of Standards and Technology, “DIGITAL SIGNATURE STANDARD (DDS)”, Federal Information Processing Standards Publication 186-2, Jan. 27, 2000). For the DSS, NIST recommends either RSA or Elliptic Curve Digital Signature Algorithm (ECDSA), where the specific recommended elliptic curves for Federal Government use are included in Appendix 6 of FIPS 186-2. ECDSA is intended for digital signatures only and is not suitable for document encryption. Since DSS is also based on algebraic functions in conjunction with hash algorithms, the problems as described above are a matter of concern. The methods of the present invention does not use any hash functions but signs a document dependent on every single bit of the document, and dependent on the signing date and on the signer's private and secret key. Any change—independent of by whom, by what, by when, and by where—of the signed document will result in an invalid signature confirmation.

Concluding: In contrary to RSA, ElGamal, AES, and DSS, the present invention makes it principally impossible to find discrete reversal functions or private keys by algebraic and statistical attacks. The recursive application of the logistic equation produces very quickly very high non-linear functions of arbitrary and unknown polynomial order. Together with the so-called self-similar nature of the logistic equation, which produces functional values absolutely chaotically within a well-limited solution interval, but containing an infinite number of solutions, it is by nature impossible to reconstruct a starting value from a functional value. The only way to find a private key would be a brute force attack. Since, however, the private key is not part of the algorithm itself (as it is in the Occhipinti method) and since the private key is nothing but a password (pass phrase) of arbitrary length and content, such a brute force attack will definitely fail. This is not ensured in the Occhipinti method, where the private key is the bifurcation factor of the logistic equation and where the number of the possible private keys is well limited. The number of digits used in the extended integer domain of the present invention determines the security of the present invention. Already with number length of 90 digits (320 bits on a 32-bit platform) ensures that the solution variability is greater then the number of atoms in the universe (which is estimated to be 10⁸⁰). Hence, the method of the present invention is unbreakable.

### SUMMARY OF THE INVENTION

The object of the invention is to provide a method and system for authentication, digital signature, and digital encryption, which is an advance in security, usability, and scalability. In order to achieve this object, several methods and systems are provided by the invention.

The invention provides a method and system for carrying out calculations with integer arithmetic, whereby the magnitude of the integers is only restricted by the addressable memory of its system implementation. This integer engine implies the generation of integer numbers of theoretically arbitrary magnitude as well as all the arithmetic operations necessary to perform any mathematical computations. The integer engine is the computational basis of the chaos generator.

The invention provides a chaos generator on the basis of a chaos function like, for instance, the Logistic Equation whereby all computations are carried out with the above integer engine, thus ensuring platform independency and theoretically arbitrary accuracy of all calculations. This chaos generator transforms the solution domain of fractioned rational numbers, for the Logistic equation in the interval [0, 1], onto the solution domain of integer numbers, for the Logistic equation in the interval [0, Aⁿ] whereby A is the radix of the number system used (for instance A=16 for hexadecimal, A=10 for decimal numbers, A=8 for octal system), and whereby the number n may have an arbitrary magnitude theoretically. Practically on a 32-bit machine the number n can reach 9,663,676,416 at maximum for A=10 Oust for illustration purposes the decimal system A=10 is chosen in the following). In fact, with respect to computation time for arithmetic operations and with respect to the limited addressable memory such high numbers are not usable and, fortunately, such high numbers are also not necessary. Already with n=90 the chaos generator provides more unique solutions than there are atoms in the universe (which are estimated to about 10⁸⁰).

The invention uses a (private key)-(public key-ID) pair concept in that sense, that the different private keys are nothing but different passwords of arbitrary length and arbitrary content, and that the respective public key-IDs are any appropriate unique identifiers, which ensure a definite detection of the private key by the private key owner. The concept here is not the concept of common asymmetric encryption methods, like e.g. RSA, where a document is encrypted with the public key and decrypted with the private key. The concept here uses only the private key for signing, encrypting, decrypting, and verifying and the public key-ID is used only to authenticate the signer and the respective private key used. The only but essential restrictions for generating a public key-ID for a certain secret private key is that the public key-ID must be unique with respect to a private key collection and that it must be totally impossible to infer the structure or the content of the private key or any information about it from the public key-ID.

The invention provides a method and system for chaotic digital signature using the (private key)-(public key-ID) pair and the chaos generator. The chaotic digital signature ensures the definite identification of the subscriber, and ensures that any signed document, which may contain any digital information of any kind and any length, can be checked for any attack or modification after signing. The chaotic digital signature is unique and is valid for just only the respective document and signer.

The invention provides a method and system for chaotic digital encryption using the (private key)-(public key-ID) pair and the chaos generator. The chaotic digital encryption changes chaotically the encryption key for each bit, or each byte, or each (variable) block of data, and the chaotically changing encryption keys depend also on the actual time, the actual user, and the actual document, thus ensuring absolute security. Brute force attacks and statistical attacks (these are attacks which try to find an encryption key by evaluating a cipher text with the means of statistical methods) will surely fail, also in the future, because the above mentioned solution domain cannot be checked by no machine within universe's lifetime.

The invention provides a method and system for authentication of challenge and response type combined with the chaotic encryption and signing of the invention. Authentication, encryption, and signing are performed for each single transaction thus guaranteeing absolutely secure data traffic over highly insecure transmission channels like e.g. the Internet.

All these methods and systems provided by the invention as described above are scalable in such a sense that any future increase of computational power due to future technological development is not a matter of concern with respect to security.

Further on, all these methods and systems of the invention are not restricted to a specific embodiment but rather are applicable on any kind of digital data transfer, storage, licensing, protection, etc., and on any kind of transfer method and storage medium, and on any kind of hardware and/or software implementation.

### BRIEF DESCRIPTION OF THE DRAWINGS

FIG. 1 illustrates the schematic mathematical structure of the integer engine device generating integer polynomial numbers up to a value of 10^{9,663,676,416}-1.

FIG. 2 illustrates the mathematical scheme of the byte converter device transforming byte values onto a certain integer number domain.

FIG. 3 illustrates the in pseudo code the logical structure of the byte packer device constructing integer polynomial numbers from a byte stream with the usage of the integer engine and byte converter devices.

FIG. 4 illustrates in pseudo code the logical structure of the chaos generator device constructing chaotically integer polynomial numbers with the usage of the byte packer and integer engine devices, and the transformed Logistic Equation in form of equation (17) entering the integer engine device.

FIG. 5 illustrates in pseudo code the logical structure of the chaotic bytes encoder device constructing chaotically integer polynomial numbers from a byte stream with the usage of the byte packer and chaos generator devices.

FIG. 6 illustrates in pseudo code the logical structure of the chaotic string encoder device constructing chaotically integer polynomial numbers from character strings with the usage of the chaotic bytes encoder device.

FIG. 7 illustrates the concept of generating public key-IDs from private keys with the usage of the chaotic string encoder device.

FIG. 8 illustrates in pseudo code the logical structure of the chaotic encryptor and signer (CHAES) device generating a document header, encrypting document data, and signing the document header and data with the usage of the integer engine, chaotic string encoder, and chaos generator devices.

FIG. 9a is a diagram showing the percentual distribution of characters of a test text, which contains 262,144 times the character ‘a’, before the encryption with the CHAES device.

FIG. 9b is a diagram showing the FFT spectrum of periodic signals of the test text of FIG. 9a.

FIG. 10a is a diagram showing the percentual distribution of characters after the encryption of the test text in FIG. 9a with the CHAES device.

FIG. 10b is a diagram showing the FFT spectrum of periodic signals of the test text of FIG. 10a.

FIG. 10c is a diagram showing the noise energy ratios of the FFT spectrum of FIG. 10b.

FIG. 11a is a diagram showing the percentual distribution of characters of a test text, which contains 262,144 characters formed by a sine oscillation around character ‘Z’ with a period of 1024 characters and amplitude of 32 ASCII table numbers, before the encryption with the CHAES device.

FIG. 11b is a diagram showing the FFT spectrum of periodic signals of the test text of FIG. 11a.

FIG. 12a is a diagram showing the percentual distribution of characters after the encryption of the test text in FIG. 11a with the CHAES device.

FIG. 12b is a diagram showing the FFT spectrum of periodic signals of the test text of FIG. 12a.

FIG. 12c is a diagram showing the noise energy ratios of the FFT spectrum of FIG. 12b.

FIG. 13 illustrates in pseudo code the logical structure of the key pair pool provider device delivering private keys from public key-IDs by key pair comparing and confirming with the usage of the chaotic string encoder device.

FIG. 14 illustrates in pseudo code the logical structure of the initial key provider device constructing initial keys from a document header and a document signature with the usage of the key pair pool provider and the chaotic string encoder device.

FIG. 15 illustrates in pseudo code the chaotic decryption and verifying (CHADV) device returning a proof message and the decrypted data from a document—encrypted with the CHAES device—with the usage of the integer engine, initial key provider, and chaos generator devices.

FIG. 16 illustrates a listing of the distinct actions performed by the client and/or server machines when terminating the connection of the client-server transmission channel.

FIG. 17a,b,c,d,e,f are illustrations showing in succession and in pseudo code the operating sequence of one embodiment system for secure authentication and encrypted and signed data transmissions over an insecure transmission channel with the usage of all the above described machines and devices of the invention and a 6-tier application and machine implementation.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

1. Definitions

The term “pseudo random number generator” as used herein refers to any mathematical algorithm which is able to generate iteratively a sequence of numbers such that this generated number sequence does most probably not contain any periodic signals or sub-sequence repetitions, neither in total, nor in sub-sequences, nor in its plain form, nor in its permutated forms.

The term “chaos generator” as used herein refers to a pseudo random number generator with an algorithm based on any chaotic function like, for instance, tent mapping or logistic mapping, or any other algorithm known in chaos theory.

The term “entity” as used herein refers to a person, an enterprise, an organization, or a machine.

The terms “cryptography method” and “cryptographic method” as used herein refers to any method which transforms any plaintext data into ciphertext data with the help of any secret information such that it is only possible for an entity owning this secret information to reconstruct the plaintext data from the ciphertext data, and that it is impossible for any entity not owning this secret information to reconstruct the plaintext data from the ciphertext data or to infer any informations about the content or structure of the plaintext data from the ciphertext data.

The terms “encryption” and “encrypt” as used herein refer to the transformation of plaintext data into ciphertext data with the help of a cryptography method.

The terms “decryption” and “decrypt” as used herein refer to the back-transformation of ciphertext data into plaintext data with the help of a cryptography method.

The terms “XO R” and “XORing” as used herein refer to the bitwise application of the mathematical exclusive OR bit operator onto two bytes or byte sequences. Its mathematical symbol is: ⊕. The results of applying the XOR operator onto two bits are given in the following table

| bit 1 | bit 2 | bit 1 ⊕ bit 2 |
|---|---|---|
| 0 | 0 | 0 |
| 0 | 1 | 1 |
| 1 | 0 | 1 |
| 1 | 1 | 0 |

where the value 0 denotes an unset bit and value 1 denotes a set bit.

The term “word” as used herein in the context of digital numbers refers to the internal storage unit, which is required by a machine to represent an internal integer number. For example, a 64-bit machine has a word length of 64 bits or 8 bytes.

The terms “document” and “electronic documents” as used herein refer to any kind of a digital data sequence of arbitrary length and arbitrary content.

The term “document header” as used herein refers to any digital data which contain any information or meta information about the document and its creator.

The term “meta information” as used herein refers to informations describing the structure and use of a document rather than its content.

The term “timestamp” as used herein refers to any quantity, which is unique with respect to a huge collection of timestamps. In other words, a timestamp has to be a unique quantity. A timestamp, for instance, is the actual date and time of any action performed and requiring such a timestamp. Thus, it may also contain some other information (like e.g. a time dependent random or pseudo random number generated by using a date-time integer value as the random number seed) instead of the actual date and time as long as the information is unique in time.

The terms “private key” and “secret private key” as used herein refer to an entity specific personal and secret password or pass phrase or any other bit sequence of arbitrary length and arbitrary content.

The term “public key-ID” as used herein, refers to any information in any form which allows the detection of a secret private key to use for decrypting an encrypted document with a cryptography method. In general, the public key-ID may be generated by any means with the restricting conditions that the public key-ID must be unique with respect to a private key collection and that it must be totally impossible to infer the structure or the content of the private key or any information about it from the public key-ID. In particular, the public key-ID may be a polynomial integer number generated from the private key with the chaos generator of this invention, which is a special case just for the preferred embodiment.

The term “client” as used herein refers to an entity comprising a communication device capable of exchanging electronically information with other communication devices, storing information, and performing computations according to the methods claimed, and seeking access to some specific information of a server. The client has to authenticate itself to the server before getting the access to some service.

The term “server” as used herein refers to an entity comprising a communication device capable of exchanging electronically information with other communication devices, storing information, and performing computations according to the methods claimed, and owning information, which is to be provided to certain clients only. The server identifies the client.

The term “service” as used herein refers to data, information or network (like e.g. internet or intranet) access provided by the server to the client.

The term “machine” as used herein refers to any device, which is able to perform mathematical calculations and to store digital information, and which is able to connect to other such machines in any kind (e.g. on wire, or wireless, optical, or acoustical, or electromagnetic, etc.) when electronic documents are to be transmitted.

The term “transmission channel” as used herein refers to a physical connection between two machines capable of transferring electronic data from one machine to another machine. The physical connection may by on wire, wireless, optical, acoustical, and electromagnetically. Especially does this term refer to the Internet, wired phone lines, wireless phone lines, wired data lines, wireless data lines; wherein lines can be insulated or un-insulated metallic current wires or glass fibres.

The term “insecure transmission channel” a used herein refers to a transmission channel, which is not protected against unauthorized access by unauthorized entities (e.g. the Internet).

The term “transmission protocol” as used herein refers to any kind of meta information sent by the information sending machine to the information receiving machine, defining and declaring the general structure of the information transferred (e.g. TCP/IP).

The term “software” as used herein refers to any digital code in any form, which when loaded or stored digitally onto a machine is able to perform certain tasks.

The term “hardware” as used herein refers to any technical unit generated by any technical means, which when implemented or build in into a machine is able to perform certain tasks, and which may be programmable or not programmable. In particular, this may be an integrated circuit (IC), any chip, any smart cards, or any other machine or information storage units.

It is to be understood that the singular forms of “a”, “an”, and “the”, as used herein and in the appended claims, include plural reference unless the context clearly dictates otherwise.

2. Introduction

The following description of the preferred embodiment does not restrict the general applicability of the invention, but is rather an example to illustrate the power and capability of the invention.

In general, I disclose a cryptography method, wherein a document is sequentially divided into at least one block of data bytes, B_{D}. Each block of data bytes is combined with the bytes, B_{K}, of an encryption key, P_{K}, by a combining function F=f(B_{D}, B_{K}) such that the application of this combining function yields the encrypted cipher bytes, B_{C}=F(B_{D}, B_{K}). Essential to the invention is, that said encryption keys, P_{K}, are polynomial integer numbers. These polynomial integer numbers are generated by a pseudo random number generator, and the combining function F has to fulfil the condition B_{D}=F(F(B_{D}, B_{K}), B_{K}). This combining function F may, for instance, consist of the bitwise application of the exclusive OR (XOR) bit operator onto B_{D} and the respective B_{K} such that the resulting cipher bytes are given by B_{C}=F(B_{D}, B_{K})=(B_{D}⊕B_{K}) where ⊕ is the symbol for the XOR operator.

In particular, in the preferred embodiment each block of data bytes, (B_{D})ⱼ, j={1, . . . , J}, is encrypted with the bytes, (B_{K})ⱼ₋₁, of the encryption key, (P_{K})ⱼ₋₁, resulting from the chaos generator processing of the previous block of data bytes, and with combining function F thus yielding the block of cipher bytes, (B_{C})ⱼ. The block of data bytes, (B_{D})ⱼ, are then packed into a polynomial integer number with a byte packing function G=f(B_{D}) thus yielding a byte packed polynomial integer number, (P_{bp})ⱼ=G((B_{D})ⱼ). The byte packing function G generates a polynomial integer number such that the data byte values are transformed and ordered into a polynomial integer number by any means appropriate for the number system radix actually used and appropriate for the desired length of the polynomial integer number. Then, the starting value for the Logistic equation, the polynomial integer number P₀, is gained by another combining function H=f(P_{K}, P_{bp}) applied onto (P_{K})ⱼ and (P_{bp})ⱼ such that (P₀)ⱼ=H((P_{K})ⱼ, (P_{bp})ⱼ). Then, the Logistic equation is iterated certain times with a certain bifurcation factor r thus yielding a polynomial integer number which is then the encryption key, (P_{K})ⱼ, for the encryption of the next block of data bytes, (B_{D})ⱼ₊₁. This procedure is repeated until all blocks, J, of data bytes are encrypted. Decryption is done respectively in that each block of cipher bytes, (B_{C})ⱼ, j={1, 2, . . . , J}, is decrypted with the bytes, (B_{K})ⱼ₋₁, of the encryption key, (P_{K})ⱼ₋₁, resulting from the chaos generator processing of the previous block of data bytes, and with combining function F thus yielding the block of data bytes, (B_{D})ⱼ. The block of data bytes, (B_{D})ⱼ, are then packed into a polynomial integer number with the same byte packing function G=f(B_{D}) as used for encryption thus yielding a byte packed polynomial integer number, (P_{bp})ⱼ=G((B_{D})ⱼ). Then, the starting value for the Logistic equation, the polynomial integer number P₀, is gained by the same other combining function H=f(P_{K}, P_{bp}) as used for encryption and applied onto (P_{K})ⱼ and (P_{bp})ⱼ such that (P₀)ⱼ=H((P_{K})ⱼ, (P_{bp})ⱼ). Then, the Logistic equation is iterated the same certain times and with the same certain bifurcation factor r as used for encryption thus yielding a polynomial integer number which is then the encryption key, (P_{K})ⱼ, for the decryption of the next block of cipher bytes, (B_{C})ⱼ₊₁. This procedure is repeated until all blocks, J, of cipher bytes are decrypted. The very first initial encryption key, (P_{K})₀, for encryption and decryption is gained from the secret private key, PK, and from any other information, OI, by merging the contents of PK and OI into a new information, NI; and where the bytes of NI are processed with the chaos generator, and where the resulting polynomial integer number is then used as the first initial encryption key, (P_{K})₀. Starting the chaos generator for the very first time is done with a starting value, P₀, gained by any means of packing all or a subset of bytes of NI into a polynomial integer number. The very last iteration of the Logistic equation for the very last block of data bytes yields a very last encryption key, (P_{K})_{J}, which is a polynomial integer number and which is used as the electronic signature of the document and can be proved accordingly.

In the preferred embodiment, authentication of a sending entity by a receiving entity is done as follows: A public key-ID is sent from a sending entity to a receiving entity. The receiving entity detects the respective secret private key to be used for the further communication. The receiving entity generates a timestamp, merges this timestamp and the secret private key into a new information, NI, and processes then NI with the chaos generator and then yields a check value, CV. Then, the receiving entity transmits the timestamp to the sending entity. The sending entity generates a proof value, PV, from the secret private key and this timestamp in the same way as the receiving entity generates CV, and sends then PV to the receiving entity. The receiving entity compares the received proof value, PV, with the calculated check value, CV, and then the receiving entity decides that the sending entity is the entity it pretends to be when CV is equal to PV, and decides that the sending entity is not the entity it pretends to be when CV is not equal to PV.

The preferred embodiment focuses on the decimal number system just for illustrating purposes without restricting the general applicability of the invention and its claims onto any number system

The preferred embodiment focuses on a public key-ID generated from the private key with the chaos generator of this invention without restricting the general applicability of this invention and its claims.

The preferred embodiment focuses on transfers and transaction over networks like the Internet and intranet without restricting the general applicability of the invention and its claims. Just for illustration, it further focuses on a Client-Server application with the HTTP protocol of TCP/IP connections as an example without restricting the invention and its claims to just that one.

The preferred embodiment focuses on a system implementation of the devices of the invention in form of coded software executable on the above machines keeping in mind that any hardware as well as any software implementation is possible and that the claims of the invention are not affected hereby.

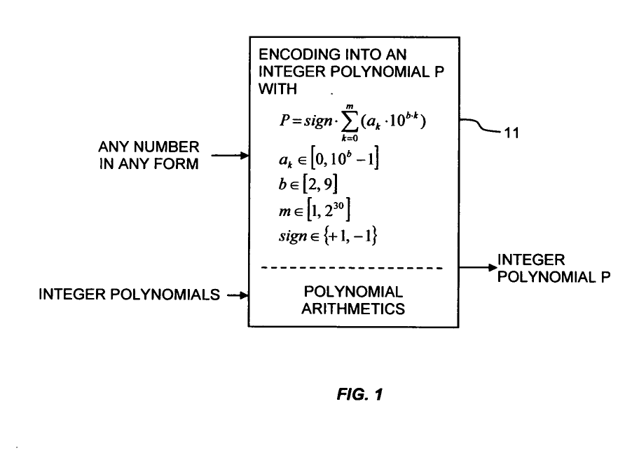

3. Integer Engine 11 in FIG. 1

On a 32-bit machine 4 bytes each of 8-bit length are used to represent internally integer numbers. These 32 bits allow signed integer numbers (one bit for the sign) with values up to 2³¹-1=2,147,483,647. In general, the integer engine constructs integers as polynomials of the form

$$P = sign \cdot {\sum }_{k = 0}^{m} ( {a}_{k} \cdot {A}^{b \cdot k} ) \\ A ∈ [ 2 , {2}^{i} ] \\ {a}_{k} ∈ [ 0 , {A}^{b} - 1 ] \\ b \leq int ( \frac{i \cdot log 2}{2 \cdot log A} ) \\ m ∈ [ 1 , {2}^{i - 2} ] \\ sign ∈ \{ + 1 , - 1 \} \qquad ( 3 )$$

which are stored as integer arrays of length m in little-endian scheme (that is the lowest address contains the lowest value), and where A is the number system radix, i is the number of bits available for the implementing machine internal representation of an unsigned integer value, and where each array element aₖ, that is each word, is a positive definite internal integer of a maximum value of A^{b}-1, and where sign denotes the signum of number P. Maximum word power m is restricted in size to 2ⁱ⁻² instead of 2ⁱ-1 due to internal arithmetical needs. The value b depends on the number system used and on the implementing machine in order to allow integer multiplication within the integer domain. If the implementing machine allows integer addressing up to 32 bits only, then b=4 for the decimal number system (A=10) has to be chosen. In the preferred embodiment, the machine allows integer addressing up to 64 bits in form of a so-called “long” default data type. Thus, without restricting the claims of the invention, in the preferred embodiment and for illustrating purposes
i=64
A=10
b=9 (4)
is set, that is the upper limit value of each aₖ is 999,999,999 (in the hexadecimal number system A=16, for instance, this would yield b=8 and a maximum value for each aₖ as 16⁸-1=4,294,967,295). It is noted explicitly that this polynomial form is not identical to common encoding with radix 2, as e.g. used in the big-endian encoding Java class BigInteger contained in the Java 2 Platform API by Sun Microsystems Inc. All the arithmetic operations needed for the integer operations in the chaos generator are implemented in the integer engine, which also allows the output of the polynomial number as a natural number in form of a string of characters.

The maximum integer value, which can be calculated in the preferred embodiment with the above polynomials is

$$\begin{matrix}{P}_{max} = sign \cdot ( {( {10}^{9} )}^{1 , 073 , 741 , 824} - 1 ) \\ = sign \cdot ( {10}^{9 , 663 , 676 , 416} - 1 ) ; sign ∈ \{ + 1 , - 1 \}\end{matrix} \qquad ( 5 )$$

theoretically. Practically however this is restricted by the addressable machine memory which, however, is not a matter of concern: For example, let us address an amount of 100,000 bytes, that is just 100 KB, which is no problem for any machine nowadays, for the representation of one number P. Keeping in mind that one internal integer addresses 4 bytes in a 32-bit machine, this yields a maximum, machine limited, integer number of

$$\begin{matrix}{P}_{max lim} = sign \cdot ( {10}^{9 \cdot 25 , 000} - 1 ) \\ = sign ( {10}^{225 , 000} - 1 ) ; sign ∈ \{ + 1 , - 1 \}\end{matrix} \qquad ( 6 )$$

which actually still is such a huge number, which is not necessary at all.

As it is obvious, addressable memory is of minor importance considering the upper limit of polynomial integers. A more restrictive quantity is the capability of the implementing machine to perform polynomial arithmetic quickly. For example, for multiplying two polynomials of an array length of 1000 each, the machine needs to perform 1,000,000 internal integer multiplications in the worse case. This is not a matter of serious concern. As already said above, a solution domain of 10⁹⁰ exceeds already universe's atom content, and in fact 10⁴⁵ will suffice already by far and—regarding equation (4)—just needs only 25 internal integer multiplications for multiplying two polynomials with an array length of 5 words.

The required platform independency of the integer engine is obvious. Considering for example the string representation of number N=65,095,880,309,854,981 which the integer engine uses to construct the polynomial number P(N). With A=10 and assuming that three different machines are using b=4, b=5, and b=9, respectively, then P(N) is defined as
with b=4: P(N)=6×10¹⁶+5,095×10¹²+8,803×10⁸+985×10⁴+4,981×10⁰
with b=5: P(N)=65×10¹⁵+9,588×10¹⁰+3,098×10⁵+54,981×10⁰
with b=9: P(N)=65,095,880×10⁹+309,854,981×10⁰

Though b might be different from one machine to another machine, nevertheless all three numbers P(N) denote exactly the same value, and since polynomial integer arithmetic operations are identical on all machines, and since exchanging numbers P between any machines is done with their string representation, the integer engine yields identical results on every machine. In order to minimize the effort for polynomial arithmetic, like e.g. multiplication, b should be chosen as high as possible.

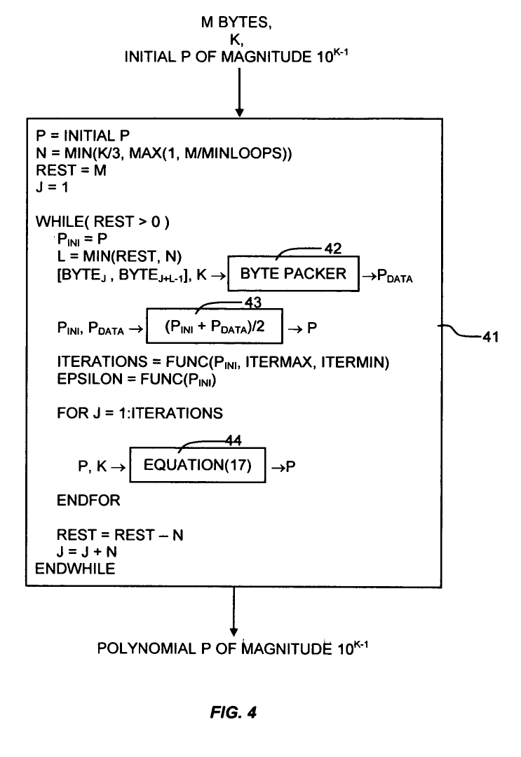

4. Chaos Generator 41 in FIG. 4

The chaos generator is based on the Logistic Equation as defined in equation (1). Varying factor r, as e.g. it would be the case when using r as the private encryption key, is a matter of concern with respect to the occurrence of high-frequent n-cycle attractors as e.g. it is the case when choosing a value of r within the range of 3.829<r<3.842. By keeping r constant for all computations, a check e.g. by means of the Lyapunov Exponent λ, which takes the form for the Logistic equation as

$$λ = ln r + {lim}_{m -> ∞} ( \frac{1}{m + 1} {\sum }_{i = 0}^{m} ln \vert 1 - 2 {x}_{i} \vert ) ; m ∈ \{ 0 , 1 , … , ∞ \} \qquad ( 7 )$$

and indicates whether or not this value produces any high-frequent n-cycle attractors, has to be conducted just only once and then never more. Besides that, due to the high solution domain provided by the integer engine, a constant value of r is also no restriction any more with respect to ensuring a temporal und spatial unique result for each generator activation. Further on, the more factor r is in the vicinity of value 4, the more chaotic the system behaves. Thus, a constant value for r in the vicinity of value 4 also ensures maximum chaotic divergence in the solution domain for every chaos generator activation. The value r=4 itself is avoided in order to ensure, that the system does not leave the solution domain due to any computational truncation error. One of such an optimal value is
r=3.99+ε; ε ∈ {−0.005, +0.005} (8)
which is used in the preferred embodiment without restricting the claims of the invention, and where e allows some dynamical fluctuations of r around the constant value. Looking somewhat closer to equation (1), it is obvious that the interval boundary values 0 and 1 are “forbidden” as starting values x₀. The value x₀=1 enters immediately into the attractor x₀=0. Also “forbidden” as starting values are all the further n-cycle attractors of the system. These attractors are defined by all the polynomials
xₙ=r·xₙ₊ₘ(1−xₙ₊ₘ) ∀ n,m∈ {0,1, . . . , ∞} (9)
This yields with m=0 and after eliminating the solution x=0, that the solution
x=r−1/r (10)
is also an attractor and “forbidden” as starting value x₀.

With m=1, equation (9) yields—after eliminating the attractor x=0—the polynomial of 3^{rd} order
r³x³−2r³x²+(r³+r²)x−r²+1=0 (11)

After further eliminating the attractor of equation (10) by polynomial division, equation (11) yields a polynomial of 2^{nd} order as
r²x²−(r²+r)x+r+1=0 (12)
with the two further attractors as

$${x}_{1 , 2} = \frac{r + 1 \pm \sqrt{{r}^{2} - 2 r - 3}}{2 r} \qquad ( 13 )$$

which also are “forbidden” as starting values. Obviously, from m=1 on, all the further solutions of equation (9), which are the recycle attractors of the system, are expected to be irrational numbers. Hence, there is no danger to run into them because all starting values and all calculated numbers are finite integer numbers. Also, the more r is in the vicinity of 4, the more is the chaos increasing in that the more attractors behave like so called “Repellors”. However, in order to ensure that the chaos generator does not get trapped in any of the n-cycle attractors due to truncation errors, the representation of the calculated values with as many as possible digital digits is necessary and which is not guaranteed within the solution domain of internal 32-bit floating point or integer numbers.

To illustrate the importance of this fact, let us consider a practical numerical example whereby r=3.99, as depicted in equation (8), and a starting value of x₀=0.1 is used:

| Decimal | Iteration Steps | | Iteration Step | Cycle Length | Percentage | Lyapunov Exponent |
|---|---|---|---|---|---|---|
| Digits Of | When Entering | Iterated | Of First | Of The | Of Original | When Entering |
| Truncation | The Attractor | Value | Occurrence | Attractor | Solution Domain | The Attractor |
| 4 | 179 | 0.9974 | 86 | 93 | ≈2% | −∞ |
| 5 | 65 | 0.99094 | 23 | 42 | ≈0.05% | 0.623 |
| 6 | 1272 | 0.910149 | 160 | 1112 | ≈0.1% | 0.640 |
| 7 | 2740 | 0.0414340 | 1038 | 1702 | ≈0.03% | 0.640 |
| 8 | 2907 | 0.99749803 | 1680 | 1227 | ≈0.003% | 0.632 |
| 9 | 13788 | 0.168906878 | 3466 | 10322 | ≈0.001% | 0.640 |
| 10 | 87984 | 0.9974999999 | 36499 | 51485 | ≈0.001% | 0.640 |

The above table shows that when truncating every result after 4 decimal digits, that is transforming the solution domain onto an integer domain of [0, 10⁴], then the computation yields after 179 iterations the value x₄₇₉=0.9974. This, however, already occurred at iteration step number 86 as x₈₆=0.9974. Thus, due to the truncation error, the system is trapped into a 93-cycle attractor after 179 iterations already. The solution domain is actually reduced to just 179 different numbers, which is about 2% of the possible 10⁴. When truncating every result after 10 decimal digits, then the computation yields after 87984 iterations the value x₈₇₉₈₄=0.9974999999 which already occurred as x₃₆₄₉₉. The system is trapped into a 51485-cycle attractor after 87984 iterations already. The solution domain is actually reduced to just 87984 different numbers, which is about 0.001% of the possible 10¹⁰. Thus, behavior is really the result of the truncation error. This is obvious when looking at the Lyapunov Exponent which indicates a well developed chaotic system, except in the case “4 decimal digits” where x=0.5 occurs while iterating and which yields a Lyapunov Exponent of negative infinity.

Now, the same calculations are done with a starting value of x₀=0.3:

| Decimal | Iteration Steps | | Iteration Step | Cycle Length | Percentage | Lyapunov Exponent |
|---|---|---|---|---|---|---|
| Digits Of | When Entering | Iterated | Of First | Of The | Of Original | When Entering |
| Truncation | The Attractor | Value | Occurrence | Attractor | Solution Domain | The Attractor |
| 4 | 94 | 0.8379 | 1 | 93 | ≈1% | −∞ |
| 5 | 238 | 0.07002 | 196 | 42 | ≈0.2% | 0.638 |
| 6 | 1942 | 0.997499 | 830 | 1112 | ≈0.2% | 0.641 |
| 7 | 1711 | 0.9970521 | 754 | 957 | ≈0.02% | 0.644 |
| 8 | 3965 | 0.99749803 | 2738 | 1227 | ≈0.004% | 0.637 |
| 9 | 18670 | 0.104566992 | 8348 | 10322 | ≈0.002% | 0.639 |
| 10 | 95790 | 0.1617794476 | 44305 | 51485 | ≈0.001% | 0.640 |

The above table shows that, except of the case “7 decimal digits”, the length of the attractor is just the same, and actually it is the same n-cycle, as in the calculations with x₀=0.1 although the value entering the attractor changes. Astonishingly, this holds also for any other starting value. Thus, getting trapped into a certain n-cycle attractor is only dependent on the accuracy of the computing machine. Looking at this behavior and making the rough estimate that due to truncation errors the solution domain is restricted to 0.001% of its original size at higher accuracies, then a solution domain of 10⁴⁵ is reduced to 10⁴⁰ variations. Assuming that each iteration consumes just 1 second computing time, and assuming that the inplementing machine would be able to make 10¹² calculations per second (this is a clock speed of 1 Terahertz), then it would last 3×10²⁰ years before getting trapped into an attractor. Hence, also a brute force attack would last this time in order to infer the starting value from a calculated result. For comparison: Making the same assumptions and performing the calculations in a floating point domain with 15 significant decimal digits on a 64-bit machine, getting trapped into an attractor would just last 0.01 seconds only.

Now, with the help of the integer engine of the invention, described above already, the solution domain is transformed to the integer domain as

$${P}_{n + 1} = \frac{R \cdot {P}_{n} ( {A}^{k} - {P}_{n} )}{{A}^{k + d}} ; \\ {P}_{n} ∈ [ 0 , {A}^{k} ] ∀ n ∈ \{ 0 , 1 , … , ∞ \} \\ A ∈ [ 2 , {2}^{i} ] \\ R = r \cdot {A}^{d} \\ d ∈ {N}^{+} \qquad ( 14 )$$

where P is the integer in polynomial form as depicted in equation (3), A is the number system radix, i is the number of bits available for the implementing machine internal representation of an unsigned integer value, k is the desired magnitude of the integer solution domain [0, A^{k}], N⁺ is the set of all positive definite natural numbers, and d is a scaling factor which is chosen is such a way that all (decimal) digits of r after the (decimal) point are considered and that k+d is a multiple of b in equation (3). The latter is done for performance purposes: Polynomial division is the most time consuming operation. With scaling factor s, this polynomial division is reduced to simply truncating the least significant polynomial words. Without restricting the claims of the invention, in the preferred embodiment it is set
k=45 (15)
keeping in mind, that k can be set to any arbitrary value, where however k=45 should be used as a lower limit. Now, equation (14), together with equations (4), (8), and (15) yields

$$r = 3.99 ⋀ i = 64 ⋀ A = 10 ⋀ b = 9 ⋀ k = 45 ⇒ d = 9 ⇒ \\ R = 3 \text{,} 990 \text{,} 000 \text{,} 000 \\ {P}_{n + 1} = \frac{R \cdot {P}_{n} ( {10}^{45} - {P}_{n} )}{{10}^{54}} ; \\ {P}_{n} ∈ [ 0 , {10}^{45} ] ∀ n ∈ \{ 0 , 1 , … , ∞ \} \qquad ( 16 )$$

and division by 10⁵⁴ is just done by truncating the 6 least significant polynomial words. Further on, for purposes of unifying the results to a certain length of digits, the original interval [0, 1] is transformed onto the integer interval [A^{k-1}, A^{k}] instead of [0, A^{k}]. Keeping in mind, that P≧A^{k} and P≦A^{k-1} are forbidden as starting values and also are never reached while iterating the logistic equation, thus all calculated results have a length of exactly k digits. This reduces the solution domain from A^{k} different numbers to A^{k}−A^{k-1}=(A-1)xA^{k-1} which is not a real constraint. This exchanges equation (14) by

$${P}_{n + 1} = {A}^{k - 1} + R \frac{( {P}_{n} - {A}^{k - 1} ) ( {A}^{k} - {P}_{n} )}{{A}^{k - 1 + d}} ; \\ {P}_{n} ∈ [ {A}^{k - 1} , {A}^{k} ] ∀ n ∈ \{ 0 , 1 , … , ∞ \} \\ A ∈ [ 2 , {2}^{i} ] \\ R = \frac{r \cdot {A}^{d}}{A - 1} \\ d ∈ {N}^{+} \qquad ( 17 )$$

Now, equation (17), together with equations (4), (8), and (15) yields

$$r = 3.99 ⋀ i = 64 ⋀ A = 10 ⋀ b = 9 ⋀ k = 45 ⇒ d = 10 ⇒ \\ R = 4 \text{,} 433 \text{,} 333 \text{,} 333 \\ {P}_{n + 1} = {10}^{44} + R \frac{( {P}_{n} - {10}^{44} ) ( {10}^{45} - {P}_{n} )}{{10}^{54}} ; \\ {P}_{n} ∈ [ {10}^{44} , {10}^{45} ] ∀ n ∈ \{ 0 , 1 , … , ∞ \} \qquad ( 18 )$$

where again division by 10⁵⁴ is just done by truncating the 6 least significant polynomial words. Note that in equations (16) and (18) the value of e according to equation (8) is set to e=0 for simplicity only without restricting the claims of the invention, and that using values e ? 0 requires a respective correction of parameter d by the additional digits used for e. Another way to achieve unification in that all the calculated results are of k digits length, is just using

$${P}_{n + 1}^{*} = \frac{R \cdot {P}_{n} ( {A}^{k} - {P}_{n} )}{{A}^{k + d}} ; \\ {P}_{n} ∈ [ 0 , {A}^{k} ] \\ A ∈ [ 2 , {2}^{i} ] \\ {P}_{n + 1} = \{ \begin{matrix} {P}_{n + 1}^{*} & if {P}_{n + 1}^{*} > {A}^{k - 1} \\ {A}^{k} - {P}_{n + 1}^{*} & if {P}_{n + 1}^{*} \leq {A}^{k - 1}\end{matrix} \} ; \\ {P}_{n + 1} ∈ [ {A}^{k - 1} , {A}^{k} ] \\ R = r \cdot {10}^{d} \\ d ∈ {N}^{+} \qquad ( 19 )$$

instead of equation (14). Equation (17), however, should be preferred, and actually is the form used in the preferred embodiment.

Concluding the description of the chaos generator of the invention, it is this advantage to freely choose values for r and k which guarantees—together with the integer engine of the invention—platform independency, optimal chaotic behavior all the time, optimized polynomial integer arithmetic, and unlimited scalability, which all together guarantees absolute security. The further description focuses on i=64 and A=10, the decimal number system, for illustrating purposes without restricting the general applicability on any number system.

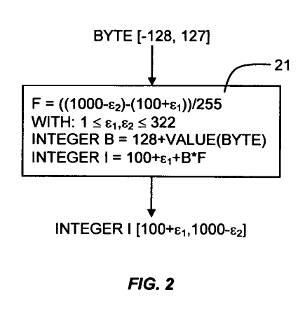

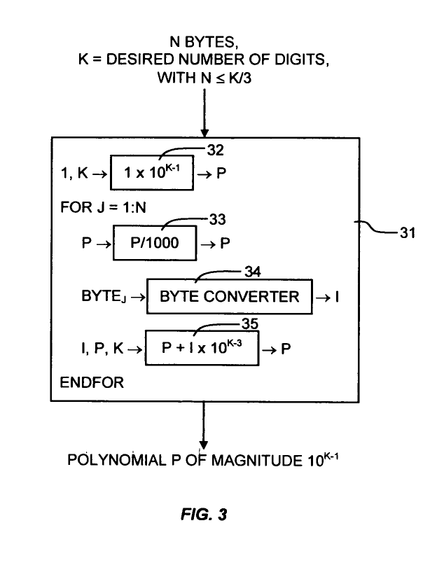

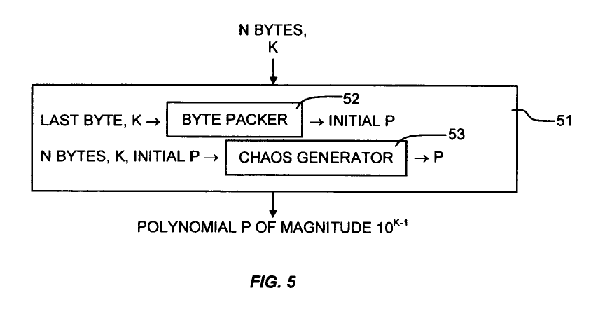

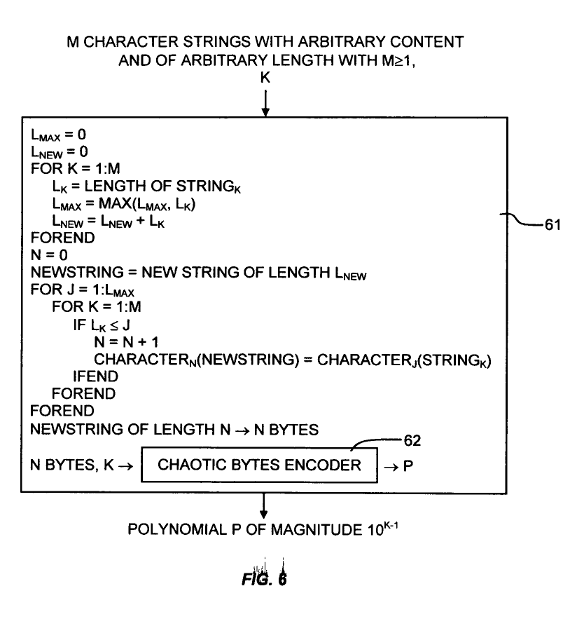

In practice, the chaos generator 41 in FIG. 4 is started with any initial value P, which is a integer polynomial number of magnitude 10^{k-1}. This initial value P is generated with the chaotic string encoder 61 (FIG. 6) which uses any arbitrary input strings and returns an integer polynomial P of magnitude 10^{K-1} with the usage of the chaotic bytes encoder 62 (51 in FIG. 5). The chaos generator 41 in FIG. 4 is further feed with any arbitrary byte stream of any arbitrary length M, where these bytes are handled block wise in such that the block length N is given as the minimum of K/3, where 10^{K-1} is the desired magnitude of the polynomial integer number, and of M/MINLOOPS, where MINLOOPS determines that the encoding algorithm (this is the WHILE-loop in FIG. 4) is performed for at least MINLOOPS times in order to make any recursive back-calculation impossible. In the preferred embodiment, MINLOOPS=10 is set, but could either be any other rasonable value or be handled dynamically in any kind. The first block of N bytes are packed into a polynomial integer number P_{DATA} with the byte packer 42 (31 in FIG. 3), which implements the byte converter 34 in FIG. 3 (21 in FIG. 2). The byte converter is constructed in such a way, that it does not produce any symmetric values in the sense of the logistic equation, where a start value of x would produce the same result as the start value x′=(1-x). P_{DATA} is then added to P_{INI} with integer engine 43 (11 in FIG. 1), then dividing this result by 2 with integer engine 43 yields the polynomial integer number P for starting the iteration of the Logistic equation. This is an essential step which ensures leaving the previous solution domain and entering a new one. The Logistic equation is then calculated according to equation (17) with the integer engine 44, where bifurcation factor r may dynamically vary around the constant value as r=3.99+e with an e in the rang of [−0.005, +0.005] somehow functionally dependent on the value of integer number P_{INI}. This function may be quite arbitrary, however should use value P_{INI} in any way thus making the variation of bifurcation factor r also chaotically. The number of iterations is determined by any function of value P_{INI} and an upper and lower iteration steps limit. This function may be quite arbitrary, however should use value P_{INI} in any way thus making the variation of iteration steps also chaotically and thus making a recursive back-calculation impossible. After these iterations the chaos generator 41 yields a new polynomial integer number. If there are any bytes left in the byte stream, this new number P will become the new initial value P_{INI}, the next N bytes are packed with the byte packer 42 and calculations repeat like described for the previous N bytes. If there are no more bytes left, then the new polynomial integer number is the result of the chaotic encoding of the byte stream. This result is unique for just this byte stream and will be quite different when modifying even a single bit of it.

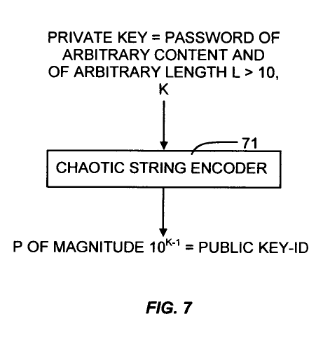

5. Description of the Private Key and Public Key-ID Concept in FIG. 7

The secret private key is nothing else but a secret password of arbitrary content and of arbitrary length, which, however, should contain 10 characters at least. The longer the password the better. This password is secret, thus it must not be transferred over an insecure connection. In order to restrict password exchange over a secure connection with another entity to just one time, a chaotic password number, which is called “public key-ID” in the following, is calculated with the chaotic string encoder 71 (61 in FIG. 6). This public key-ID can be transferred over an insecure connection to another entity without any security restriction, because it is impossible to infer the secret private key from the public key-ID. The advantage of calculating this public key-ID is obvious: any entity may build its own private database of (private key)-(public-key-ID) pairs for each entity only once, and then each entity may identify itself with the help of the public key-ID in that the partner looks up the respective private key from its database by just comparing the public key-IDs. In fact, the public key-ID is used only for the identification of another entity, while actually only the private key is used for chaotic encoding of any kind. Otherwise a third party could easily pretend to be somebody else by getting knowledge of the public key-ID.

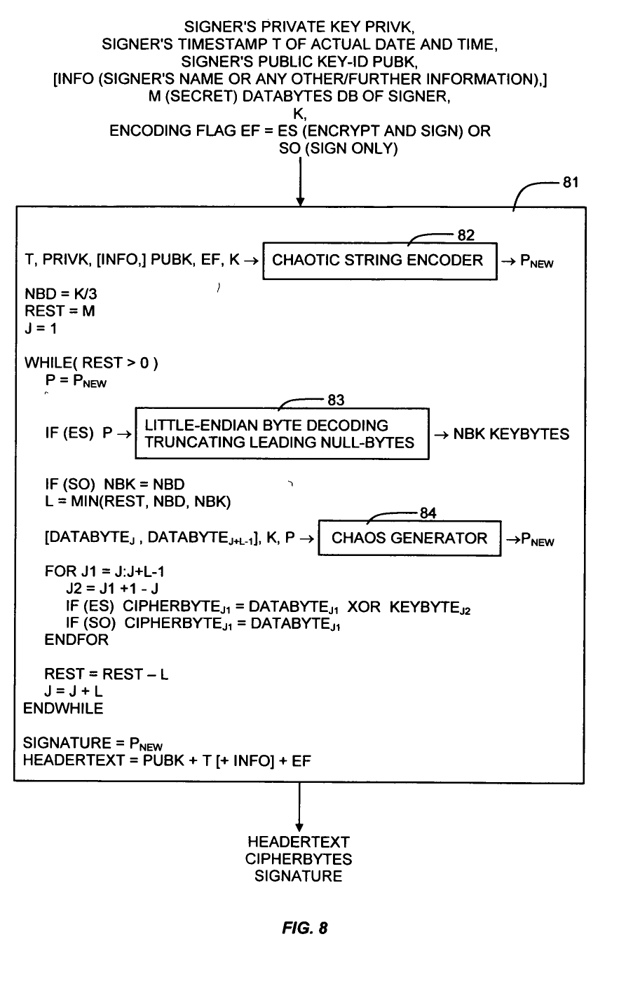

6. Chaotic Data Encryption and Digital Signing with the Chaos Encryptor and Signer 81 in FIG. 8

The chaos encryptor and signer (abbreviated with “CHAES” in the following) 81 is feed with the signer's private key, a timestamp containing the actual date and time of the signing process, the public key-ID, optionally with further information about the signer like e.g. its name, the (secret) data of the signer to be (encrypted and) signed, the desired length of the numbers P used for chaotic encoding, and a flag indicating whether to just sign the data (SO) or to encrypt and sign (ES) them in the case the data are secret. First, the timestamp, private key, optionally additional signer info, the public key-ID, the encoding flag, and K are sent to the chaotic string encoder 82, which is 61 in FIG. 6. The order in which the information is sent is handled in a special protocol because it is essential for the process that the decrypting and the verifying machine performs this in exactly the same way. It is also essential that at least the private key and the timestamp is sent to the chaotic string encoder 82 in order to get a unique number P_{NEW},. It is also essential that all the information which build the header of the encoded data enter the chaotic string encoder 82 in order to make them part of the signed information. The chaotic string encoder 82 returns the first integer polynomial number P_{NEW}., which is unique due to private key and timestamp encoding. The block length L for encoding the data is given by NBD=K/3 since the byte packer 31 is able to pack K/3 bytes in one integer polynomial number P. If the encoding flag is set to ES, that is to encryption and signing, then the block length L is further restricted to L=Minimum(NBD, NBK) where NBK is the number of bytes resulting from the little-endian decoding of a integer polynomial number P in the integer engine 81, which is 11 in FIG. 1. In the case of ES, the initial number P_{NEW} is decoded to its bytes, which are called “key bytes”, then the first block of data bytes is sent to the chaos generator 84, which is 41 in FIG. 4, which returns a new integer polynomial number P. If SO is set, the data bytes are not changed. If ES is set, then the original data bytes of this block are XOR-ed with the key bytes thus yielding the encrypted cipher bytes of this block. If there are any data bytes left in the byte stream, the encoding procedure starts again for the next block of data bytes while setting the new number P_{NEW} as the encryption key for the next block (in the case of ES), and as the new initial value for the chaos generator 84. If there are no bytes left any more in the byte stream, then the new number P_{NEW} is the signature for all the encoded (and encrypted in the case of ES) bytes. After generating the header text from the information entering CHAES 81, CHAES 81 returns the header text, the encrypted/encoded cipher bytes/data bytes, and the signature of the encoded data.

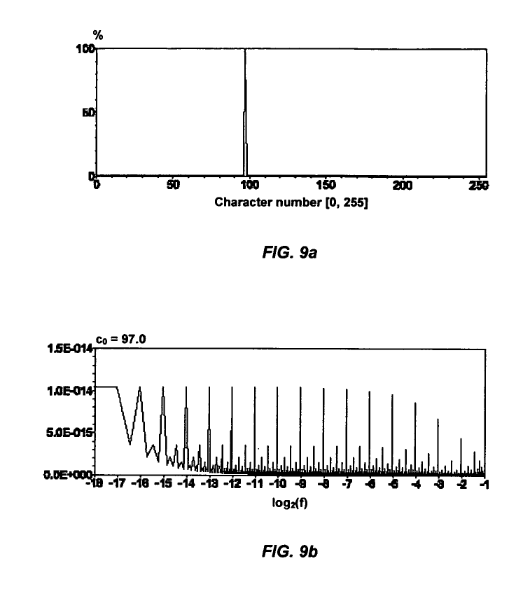

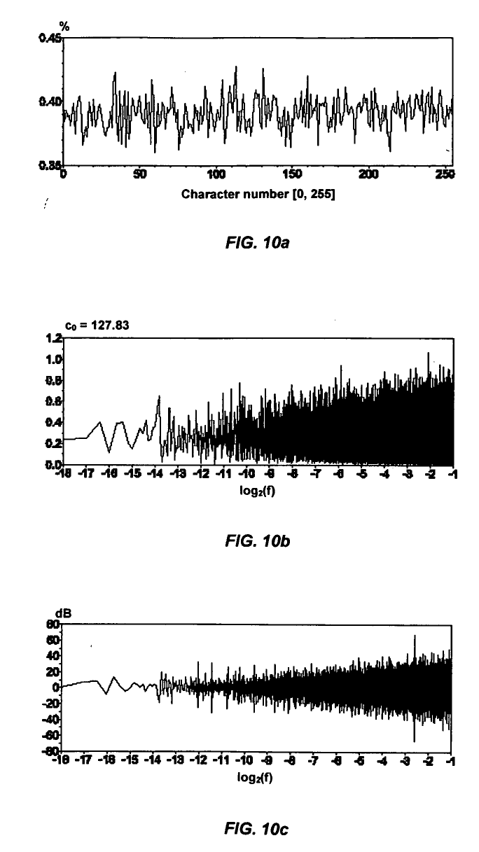

Example: In order to test the reliability and statistical independency of the encryption, a byte stream was generated which contains 262,144 (L=2¹⁸) times the character ‘a’, which is character number 97 in the ASCII table. The character distribution of this byte stream is depicted in FIG. 9a showing that character number 97 fills the byte stream with 100%. FIG. 9b depicts the amplitudes spectrum computed with the Fast Fourier Transform (FFT) of this byte stream, showing that around the mean of 97 the byte stream does not contain any periodic signal or any noise. Then, the byte stream was encrypted with CHAES 81 of FIG. 8. FIG. 10a depicts the distribution of the encrypted bytes in form of character numbers of the ASCII table, showing that all characters are contained, and that all the characters are distributed between 0.36% and 0.42%. So, none of the characters has any significant higher occurrence than the others. The character distribution alone, however, gives no evidence of any possible periodic signal. Therefore, an FFT was computed to investigate that. FIG. 10b depicts the amplitudes spectrum computed with FFT: The resulting constant offset c₀ in this example is 127.83 and thus is almost equal to the arithmetic mean of 127.5. Around this offset the spectrum does not contain any significant periodic signal but rather is determined by noise. In order to determine the noise “color”, the successive noise energy ratios R_{NE} were computed with

$${R}_{NE} = 10 {log}_{10} ( \frac{{A}_{k}^{2} \cdot {ω}_{k}^{2}}{{A}_{k - 1}^{2} \cdot {ω}_{k - 1}^{2}} ) [ dB ] ; k = [ 3 , L ] ; {ω}_{k} = 2 π {f}_{k} \qquad ( 20 )$$

where Aₖ is the discrete amplitude of the noise at the circuit frequency ωₖ. These ratios are depicted in FIG. 10c, showing that the noise is uncorrelated “White Noise”.

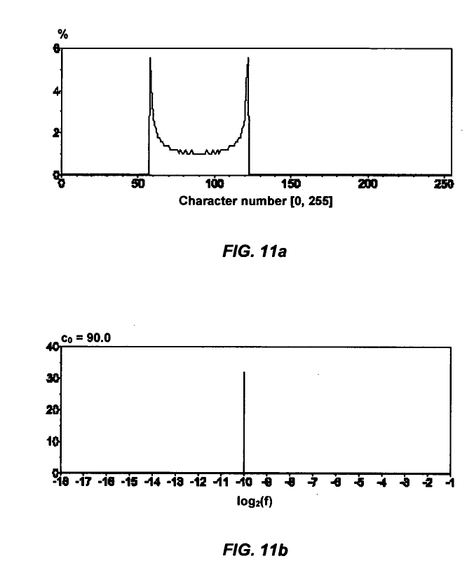

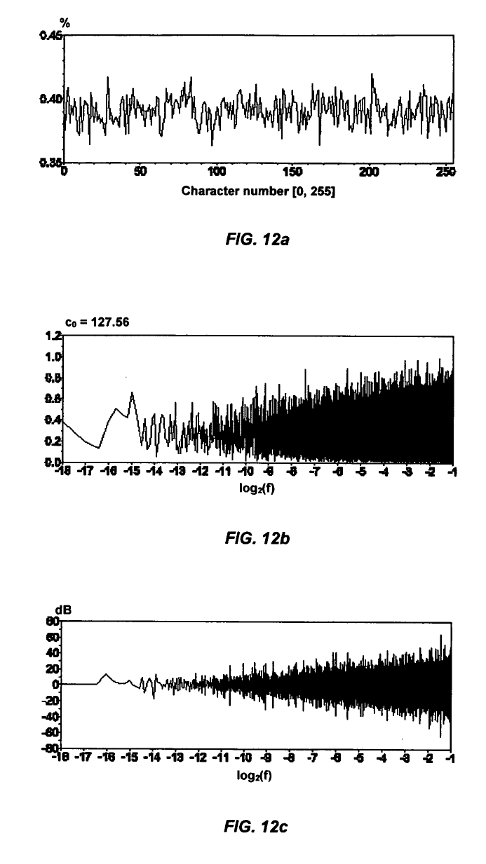

Example: Another test was performed, where another byte stream contains 262,144 characters (L=2¹⁸) which where generated by a sine oscillation around character ‘Z’, which is number 90 of the ASCII table, with a period of 1024 characters and an amplitude of 32 ASCII table numbers. The character distribution of this byte stream is depicted in FIG. 11a. FIG. 11b depicts the amplitudes spectrum of this byte stream computed with FFT, showing around the constant offset of 90 the unique peak of the 1024-period (2¹⁰) with an amplitude of 32. Then, the byte stream was encrypted with CHAES 81 of FIG. 8. FIG. 12c depicts the distribution of the encrypted bytes, showing that again all characters are contained, and that all the characters are distributed between 0.36% and 0.42%. Hence, again none of the characters has any significant higher occurrence than the others. FIG. 12b depicts the amplitudes spectrum computed with FFT: The resulting constant offset is 127.56 and thus again is almost equal to the arithmetic mean of 127.5. Again, around this offset the spectrum does not contain any significant periodic signal but rather is determined by noise. Again, the successive noise energy ratios R_{NE} were computed with equation (20). These ratios are depicted in FIG. 12c, showing that—again—the noise is uncorrelated “White Noise”.

When using the formula

$${R}_{SN} = 10 {log}_{10} ( \frac{{\sum }_{k = 2}^{L / 8} ( {D}_{k}^{2} \cdot {ω}_{k}^{2} )}{{\sum }_{k = 2}^{L / 8} ( {C}_{k}^{2} \cdot {ω}_{k}^{2} )} ) [ dB ] ; L = {2}^{18} ; {ω}_{k} = 2 π {f}_{k} \qquad ( 21 )$$

for the Signal-to-Noise-Ratio R_{SN}, where Dₖ is the discrete amplitude of the sine modulated data bytes at the circuit frequency ωₖ (FIG. 11b), and Cₖ the respective discrete amplitude of the encrypted cipher bytes (FIG. 12b), then the encryption of the test text in FIG. 11 yields a value of R_{SN}=−40 dB thus showing, together with FIG. 12c, that CHAES 81 of FIG. 8 constructs absolute chaotic White Noise, which cannot be decrypted by any statistical attack.

In summary, the advantage of the invention is, that the encryption keys are generated chaotically and are changing chaotically with every byte block. Any brute force attack thus fails as well as any attack based on any statistical evaluation of the cipher text.

A further advantage is, that the signature is the result of encoding chaotically every single byte of the data as well as of the generated header. This means, that the signature is valid just for this document containing certain data and certain information from/about the signer in its header. Changing one single bit of the encoded data will result in a total different signature.

This absolute secure encrypting/encoding method of the invention is therefore the appropriate tool in order to sign and/or encrypt any data for any purposes like e.g. secure data storage and licensing of any kind by any means, secure data transmission of any kind by any means, secure authentication/identification of a sender of information or requests by any kind by any means, legally accepted digitally subscriptions of any kind by any means, and the secure protection against any attack by any unauthorized third party.

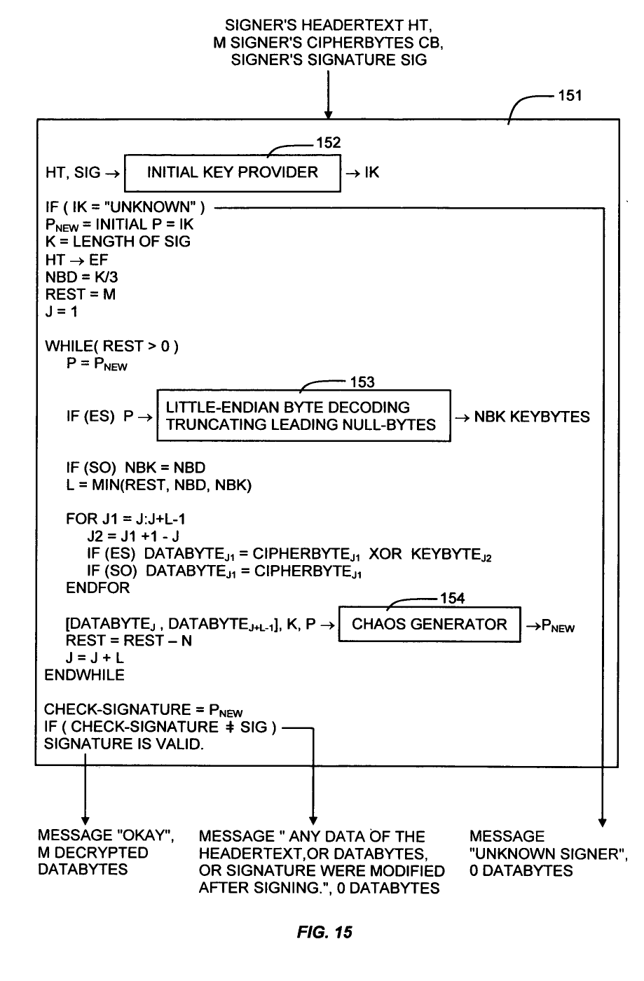

7. Chaotic Data Decryption and Signature Verifying with the Chaos Decryptor and Verifier 151 in FIG. 15

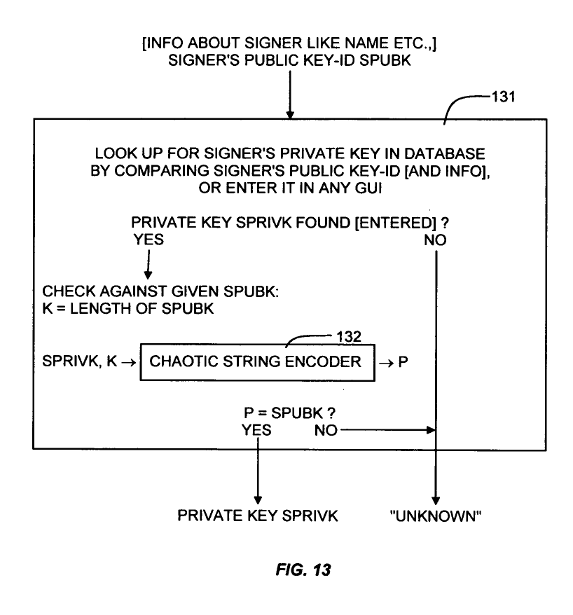

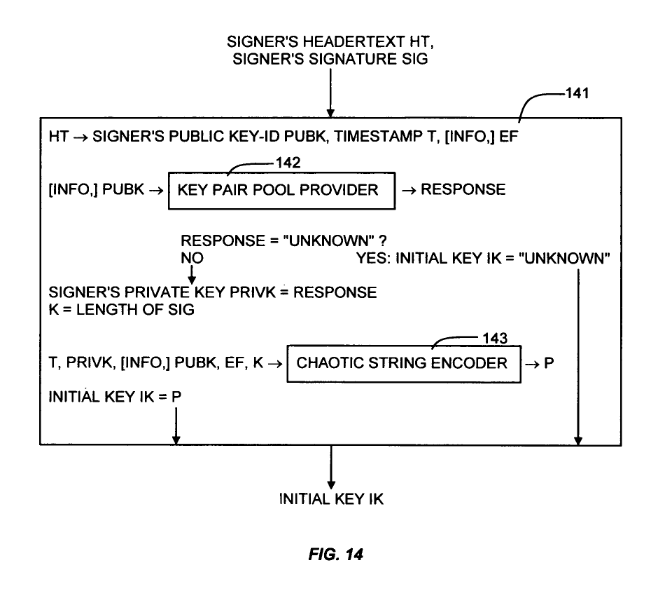

The chaos decryptor and verifier (abbreviated with “CHADV” in the following) 151 is feed with the header text, the cipher text (cipher bytes), and the signature of the signer's document encrypted with CHAES 81 in FIG. 8. The header text and signature is sent to the initial key provider 152, which is 141 in FIG. 14. The initial key provider 141 extracts the public key-ID (and optionally some more info about the signer) from the header text and sends this to the key pair pool provider 142, which is 131 in FIG. 13. In the preferred embodiment, the key pair pool provider is a local database or user interface (UI) returning the respective private key by comparing the sent public key-ID with the ones in the (encrypted) stored key pairs or by entering the password in a UI. It is noted here explicitly that this is not a restriction of the claims of the invention in that the preferred embodiment just illustrates an example. The key pair pool provider may also be realized by incorporating a local or remote third party certification authority (CA). The key pair provider may keep the key pairs and sends directly some kind of session key as response such that nobody gets knowledge of the private key except the CA and the owner itself. Now, in the preferred embodiment, the key pair pool provider 142 sends back the private key or the flag “UNKNOWN” (if there was no respective key pair found) to the initial key provider 141 in FIG. 14. If the initial key provider 141 gets the flag “UNKNOWN” from the key pair pool provider 142, it sends this flag directly back to the CHADV 151 instead of an initial key. Otherwise the initial key provider 141 uses the private key and the info stored in the header text to encode a chaotic integer polynomial number P using the chaotic string encoder 143 and the same encoding protocol as in CHAES 81. This number is then sent back as the initial key to the CHADV 151. If the initial key is nothing but the flag “UNKNOWN” then CHADV 151 in FIG. 15 returns just this flag as message. If the initial key is well defined then it is the first key P_{NEW}. This first key yields the first set of key bytes for decrypting the first block of cipher bytes by XOR-ing them with the key bytes in the case ES. In the case SO the decrypted data bytes are the cipher bytes already. Then the first block of decrypted data bytes together with the first key are sent to the chaos generator 154, which returns the next key P_{NEW}. As long as there are any bytes left in the byte stream, the procedure repeats for all following data blocks like described for the first data block. If there are no data bytes left any more, then this new key P_{NEW} is the actually computed signature. This actually computed signature must be exactly identical to the signature computed and sent by the signer. If this is not the case, then either the header text, or the cipher text, or the signer's signature has been modified unauthorized after the signing of the document. A modification of the data after signing them in even one single bit will result in a total different actually computed signature. In this case, CHADV 151 will return a respective error message. Only the case that the actually computed signature is exactly identical to the signature computed and sent by the signer gives the definite guarantee that the data are untouched.

Thus, the combination of CHADV 151 with CHAES 81 ensures that
1) The data really has been sent by the signer and not by anybody else.
2) The data have not been modified after signing them, not even in one single bit.
3) The signature is unique and only valid for just this document.
4) In the case of encryption nobody has been able to get knowledge of the content or of the kind of the data sent.

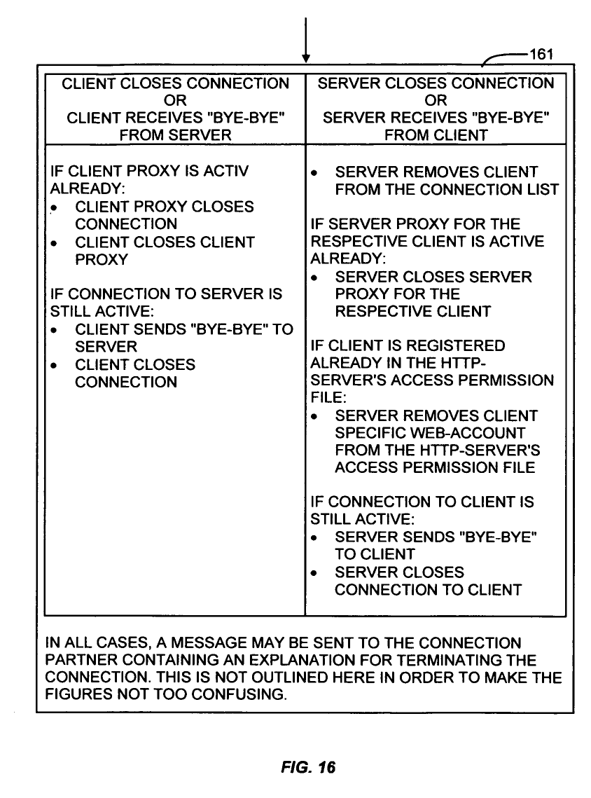

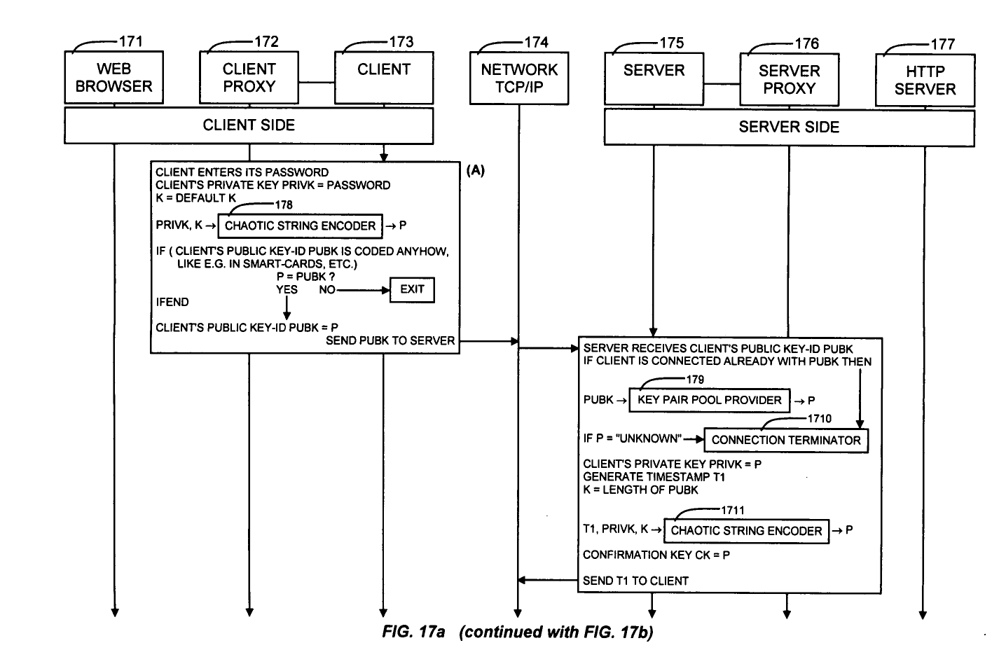

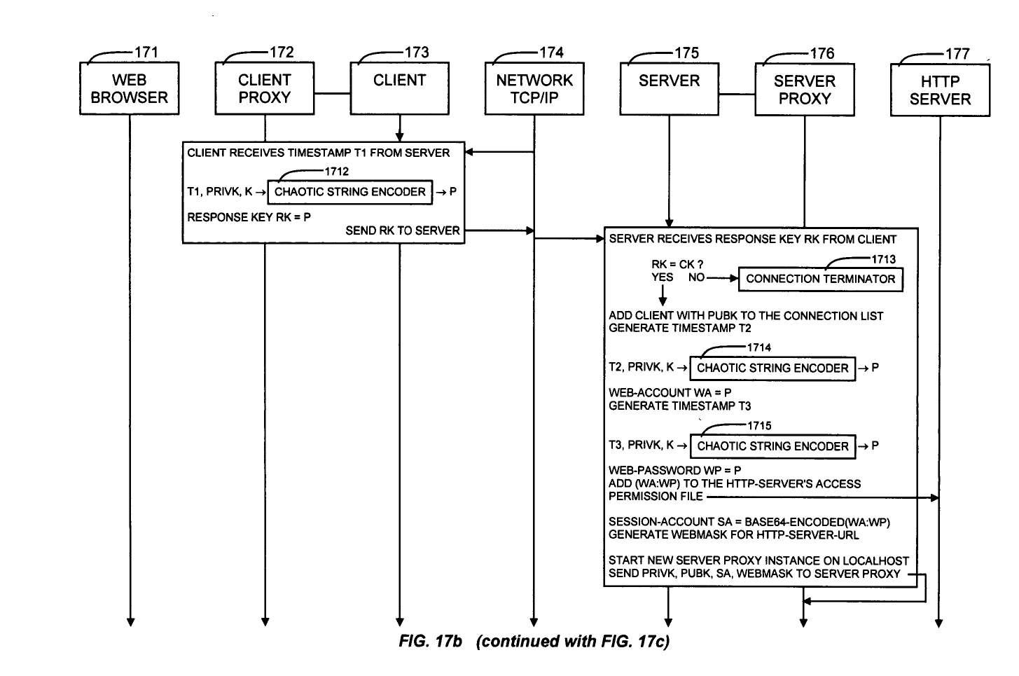

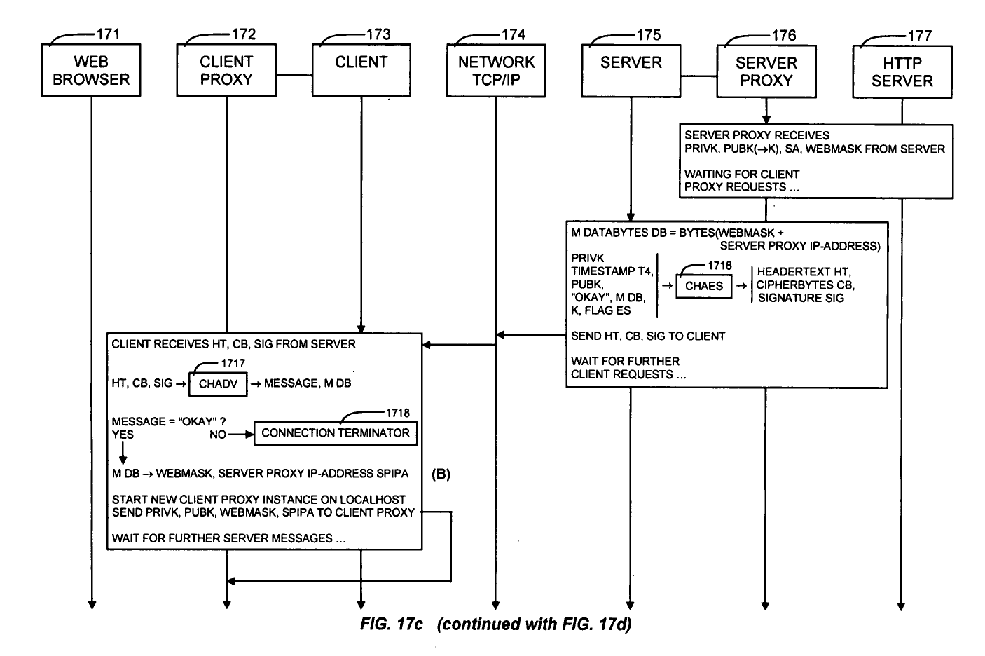

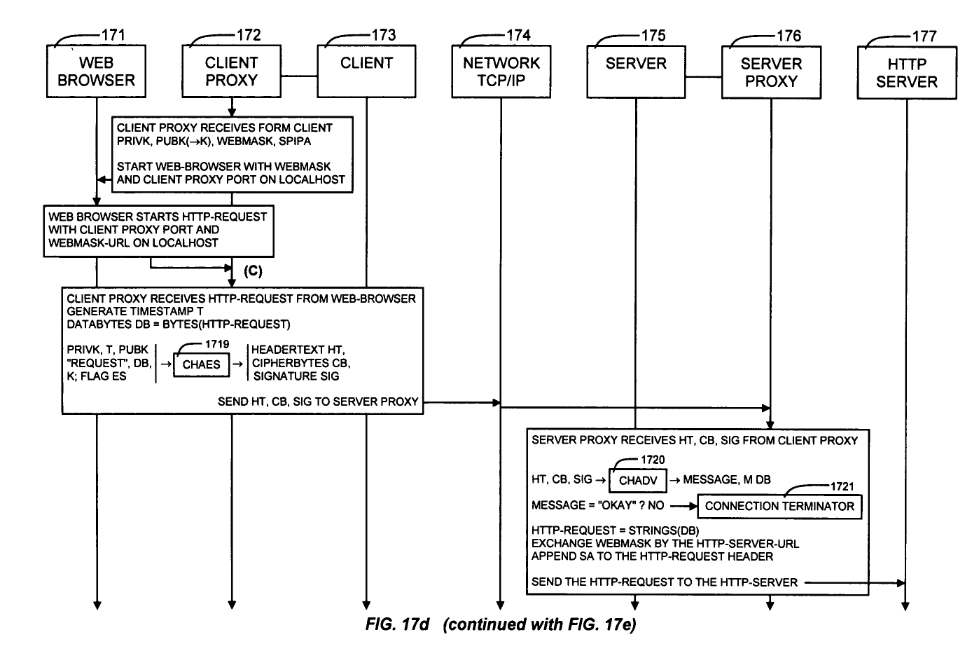

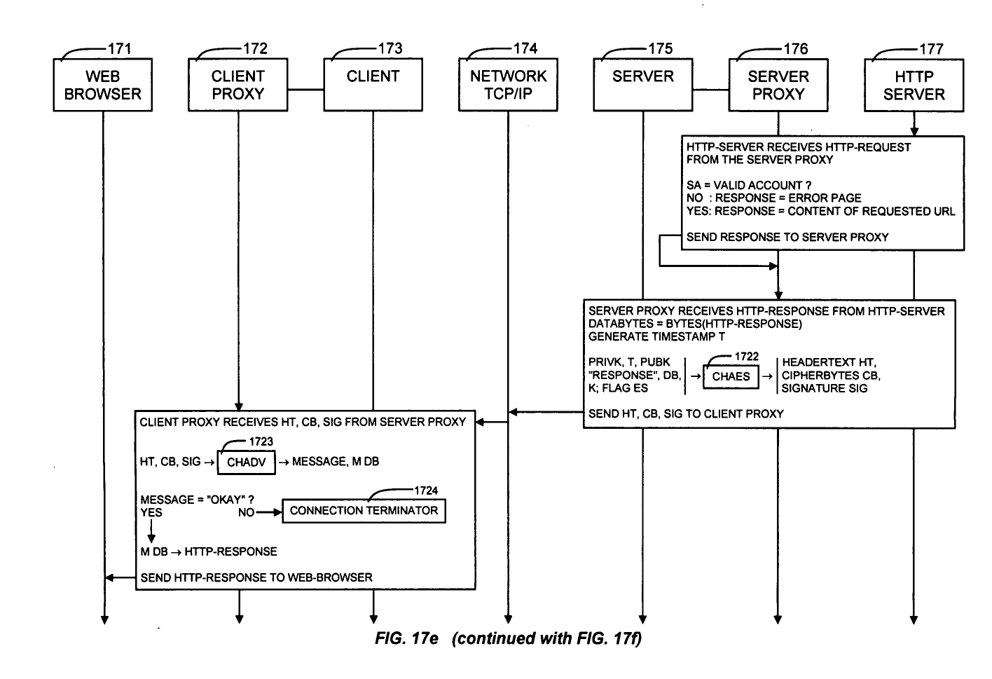

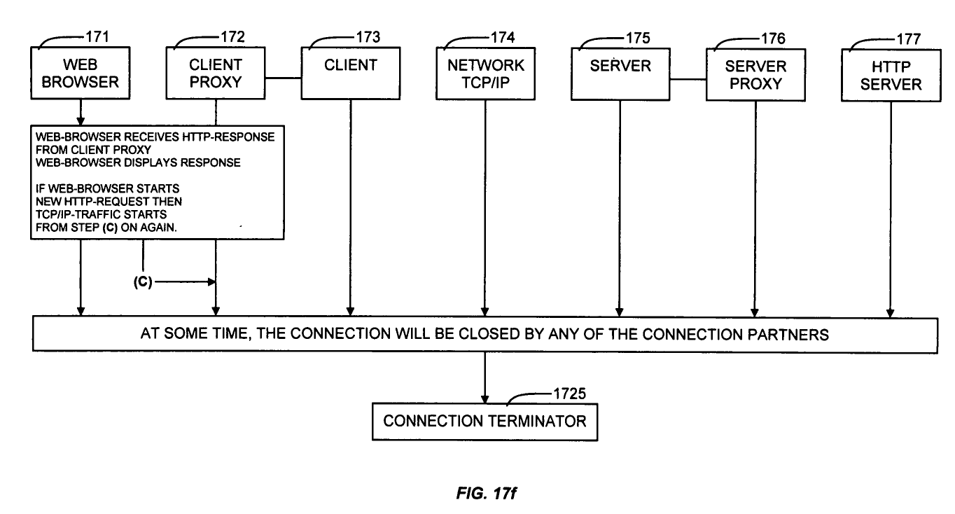

8. Example Embodiment of a Method and System for Authentication, Digital Signature, and Data Encryption/Decryption Between Remote Entities over a Network in FIGS. 16, 17a-f:

As said above, the preferred embodiment is just an example for an authentication, digital signature, and encryption/decryption method and system for using the specific chaos modules as outlined in FIGS. 1-8 and 13-15. It focuses for an example on the HTTP protocol of TCP/IP network traffic. In principle, the methods used can be implemented in quite other client/server systems (like e.g. smart cards, cell phones, banking systems, etc.) using any kind of transmission channel (wire, wireless) and any kind of transmission protocol (like e.g. TCP, UDP, HTTP, WAP, SMTP, FTP, etc.).

The system in FIG. 17 consists of a web browser machine 171, a client machine 173, and a client proxy machine 172 on the client side. All traffic between these machines is done via TCP/IP on a stand-alone station (local host) and/or within a protected intranet. On the server side, the system consists of a server machine 175, a server proxy machine 176, and a HTTP server machine 177. All machines on the server side are so-called multithreaded machines, that is they are able to handle requests from different clients parallel at the same time. All traffic between these server side machines is also done via TCP/IP on a stand-alone station (local host) and/or within a protected intranet. The network traffic between client machines and server machines is considered to run over an insecure network transmission channel (like e.g. the Internet) 174 in order to illustrate the advantages of the invention. The scenario implements that a certain client wants to connect to a certain server in order to request certain information and/or services, which are not public but rather are provided by the server for authorized and registered clients only. It further implements that the server wants to be sure, that really only that client receives any response which it pretends to be and which is registered on the server side, and that the data transfer between client and server must be secret, that is must be encrypted in such a way, that nobody else can get knowledge of the data content and kind and that any modification of the data by a third party can detected immediately.

Starting from step (A) in FIG. 17a, the client 173 enters it's password, which is the secret private key (abbreviated as “PRIVK” in the following), and the desired length of encoding into integer polynomial numbers is set to the default length K. In fact, this can be chosen freely and dynamically for any K≧45. Entering PRIVK into the chaotic string encoder 178 yields a chaotic integer polynomial number, which is the client's public key-ID (abbreviated as “PUBK” in the following). If PUBK is stored already in any form on the client machine for just this client (like e.g. in smart cards, sim cards, etc.) a first proof compares the computed PUBK with the stored one for authentication purposes. If these both numbers are not equal, any further action with the client 173 is refused by the client. If authentication was positive or the machine is not client specific coded, then the client 173 sends PUBK to the known server 175 over the network 174. The server 175 receives the client's PUBK and checks in its connection list whether or not this specific client is connected to the server in another session already. The server 175 allows only one session per time per client for security. If the client 173 is connected already in an other session, then the server terminates the actual session request with the connection terminator 1710, which is 161 in FIG. 16. Otherwise, the server 175 looks up for the respective client's PRIVK in its key pair pool provider 179 (131 in FIG. 13) by comparing the sent PUBK with the registered ones. It is noted explicitly, that the embodiment here uses a local key pair pool provider for simplicity only, and that this could also be conducted by a third party, like e.g. a certification authority, either delivering the client's private key or a private key and time dependent session key. It is also noted explicitly that the key pair pool provider 179 may contain several key pairs for the same client for different key lengths and that the default key length K is used here only for simplicity. The key pair pool provider 179 returns a response to the server 175, which is the message “UNKNOWN” in the case that PUBK is not known, or which is the client's PRIVK otherwise. In the case of “UNKNOWN”, the server 175 terminates the connection to the client 173 with the connection terminator 1710. After receiving the client's PRIVK, the server 175 generates a timestamp T1 (that is the actual date and time) and generates with T1, PRIVK, and K with the chaotic string encoder 1711 a confirmation key CK which is unique for one session and will never occur anymore due its client and time dependency. Then the server 175 sends T1 to the client 173 over the network 174.

In FIG. 17b, the client 173 receives the timestamp T1 from the server 175 and generates with the chaotic string encoder 1712 and with T1, PRIVK, and K a response key RK in exactly the same way like the server 175 has generated CK. Then the client 173 sends RK to the server 175 over the network 174. The server 175 receives RK from client 173 and compares RK computed by client 173 with CK computed by itself. If these both numbers are not exactly identical, then RK was sent by anybody else but not by the client to which the PUBK belongs. This authentication check is absolutely reliable due to its dependency on the clients PRIVK, which only the client and the server knows but never a third party, and due to its time dependency. If the authentication proof failed, the server 175 terminates the connection to client 173 with the connection terminator 1713. If authentication was successful, server 175 adds client's PUBK to the list of connected clients, and generates two more keys, web account WA and web password WP, with two more timestamps T2 and T3, and PRIVK, and K with the chaotic string encoder 1714. The combination WA-WP is added as an authorized user entry into the HTTP server's 177 access permission file in order to allow access to the account/password protected root directory of the HTTP server's URL for this account. Nobody knows this account except the server 175 and now the HTTP server 177. The server 175 further encodes the WA-WP combination into the base64 character map as the session account SA and generates a web mask, which may contain any arbitrary string of arbitrary length, for masking the HTTP server's root URL. Then server 175 starts (on local host or within the server side intranet) a new server proxy instance 176 for this specific client session and sends PRIVK, PUBK, SA, and the web mask to the server proxy 176.

In FIG. 17c, server proxy 176 receives PRIVK, PUBK (and gains K from PUBK's length), SA, and the web mask from server 175 and waits for any requests of this specific client. After the activation of the new server proxy instance 176, server 175 encodes the web mask and the server proxy's IP-address into a byte stream DB, generates a new timestamp T4, sets the encoding flag to ES (that is to encrypt and sign), and sends PRIVK, T4, PUBK, “OKAY”, DB, K, and flag ES to the chaotic encryptor and signer (CHAES) 1716. CHAES 1716 returns the protocol conform header text HT (which—of course—does not contain PRIVK, see FIG. 8), the encrypted cipher bytes CB and the signature SIG. Server 175 sends HT, CB, and SIG to client 173 over network 174. Due to the encryption, nobody gets knowledge of the web mask nor of the session specific IP-address of the server proxy instance 176, and nobody else but the client can decrypt the data because nobody else knows the client's PRIVK. Then, server 175 waits for any further client requests. Client 173 receives HT, CB, and SIG from server 175 and sends HT, CB, and SIG to the chaotic decryptor and verifier (CHADV) 1717 (151 FIG. 15). CHADV 1717 returns a message and the byte stream DB of the decrypted cipher bytes CB to client 173. If the message is not “OKAY”, then either the sender was not server 175, or anybody has modified any of the data HT, CB, or SIG. In this case, client 173 terminates this connection with connection terminator 1718. If message is “okay”, client 173 extracts the web mask and the server proxy's IP-address SPIPA from DB, starts (on local host or within the client side intranet) a new client proxy instance 172, and sends PRIVK, PUBK, web mask, and SPIPA to this new client proxy instance 172.—This step (B) is the end of the so-called hand shaking, which started at step (A) in FIG. 17a. Then client 173 waits for any further server messages.

In FIG. 17d, the client proxy instance 172 receives PRIVK, PUBK (and gains K from PUBK's length), web mask, and SPIPA from client 173 and starts the web browser 171 with the web mask and the client proxy's IP-port (on local host or with client proxy's IP-address). The web browser 171 starts a HTTP-request with the web mask-URL to the client proxy 172. Client proxy 172 receives the HTTP-request from the web browser 171, generates a new timestamp T, and encodes the HTTP-request into a byte stream DB. Then client proxy 172 sends PRIVK, T, PUBK, “REQUEST”, DB, K and flag ES (that is encrypt and sign) to the chaotic encryptor and signer CHAES 1719. CHAES 1719 returns the protocol conform header text, the encrypted cipher bytes CB, and the respective signature SIG to client proxy 172, which in turn sends HT, CB, and SIG to the server proxy 176 over network 174. Server proxy 176 receives HT, CB, and SIG from client proxy 172, and sends HT, CB, and SIG to CHADV 1720. CHADV 1720 returns a message and the byte stream DB of the decrypted cipher bytes CB to server proxy 176. If the message is not “OKAY”, then either the sender was not client proxy 172, or anybody has modified any of the data HT, CB, or SIG. In this case, server proxy 176 terminates this connection with connection terminator 1721. If message is “okay”, server proxy 176 extracts the HTTP-request from DB, exchanges the web mask with the real URL of the HTTP server's root directory, and appends the base64-encoded session account to the HTTP-request header. Then server proxy 176 sends the HTTP-request (on local host or within the server side intranet) to the HTTP server 177.

In FIG. 17e, the HTTP server 177 receives the HTTP-request from server proxy 176 and checks whether or not the session account is valid in that it is contained in its access permission file. If the session account and the URL are valid, then HTTP server 177 sends the requested content/information of this URL as response to server proxy 176. If the session account or the requested URL is not valid, the HTTP server sends as response the content of an error page. Server proxy 176 receives the HTTP-response from HTTP server 177, encodes this response into a byte stream DB, and generates a new timestamp T. Then, server proxy 176 sends PRIVK, T, PUBK, “RESPONSE”, DB, K, and flag ES (that is encrypt and sign) to CHAES 1722. CHAES 1722 returns the protocol conform header text HT, the encrypted bytes CB of the HTTP-response, and the respective signature SIG to server proxy 176. Then, server proxy 176 sends HT, CB, and SIG to client proxy 172 over network 174. Client proxy 172 receives HT, CB, and SIG from server proxy 176 and sends HT, CB, and SIG to CHADV 1723. CHADV 1723 returns a message and the byte stream DB of the decrypted cipher bytes CB to client proxy 172. If the message is not “OKAY”, then either the sender was not server proxy 176, or anybody has modified any of the data HT, CB, or SIG. In this case, client proxy 172 terminates this connection with connection terminator 1724. If message is “okay”, client proxy 172 extracts the HTTP-response from the decrypted byte stream DB and sends this HTTP-response to the web browser 171.

In FIG. 17f, the web browser 171 receives the HTTP-response from the client proxy 172 and displays the response (that is the required information) in its graphical user interface (GUI). If the web browser starts a new HTTP-request with the web mask, to the client proxy 172, then the procedure repeats from step (C) on in FIG. 17d.

If anybody from the communication partners wants to close the session, then it starts the connection terminator 1725, which by the way is also activated after a certain time of no data traffic over network 174.

In summary of FIG. 17a-f, any information, that is any data transaction (request as well as response), which is sent over the insecure network, is encrypted such that nobody is able to get knowledge neither of the content nor of the kind of the data transferred. In particular, this is highly desired with respect to transmit any secret data from the intranet over the Internet. This absolute security is guaranteed by the extreme chaotic encryption, using encryption keys changing from byte block to byte block, from transaction to transaction, from session to session, thus being unique for each single byte block-transaction-session combination.

Further on, any data transaction is signed such that a modification of even one single bit of the data after signing them results in an immediate detection of the attack. At the same time, the signature of each transaction ensures, that the session traffic is really between that client which it pretends to be and that server which has knowledge of the client's private key and which is the one owning the information required by the client. This check is performed for any single transaction and the signature is unique for each single transaction-data-session combination.

9. Further Example Embodiments of a Method and System for Authentication, Digital Signature, and Data Encryption/Decryption Between Remote Entities:

### APPLICATION EXAMPLE 1

The method disclosed here is useful for many types of communication of various applicants. One favourable example of an application of the here disclosed method for signing, encrypting and authentication is the electronic email communication between a lawyer and its client. Attorney and client agree a distinct and unique private key for the future communication and each is storing this private key (encrypted) on its computer. When the lawyer sends out a document to his client, he encrypts and signs the document using the here disclosed method and this agreed private key. He attaches the so prepared document to his email and sends it to the client. The client decrypts the document using the here-disclosed method with the same agreed private key. The process can be automated so that neither attorney nor client needs to actively encrypt or decrypt the document. By just attaching the document the document would be encrypted and by just clicking on the attachment of the incoming email the document would be decrypted. This is just an example, which can be applied to any other pair of entities exchanging documents. Further examples are the communication between attorney and attorney, accountants and client, accountant and accountant, any type of consultant and client, any type of consultant and any type of consultant, government agency and client of government agency, government agency and government agency, bank and customer, bank and bank, for profit businesses and customer, for profit businesses and for profit businesses, any sales organization and sales person out in the field, hospital and patient, hospital and hospital, physician and patient, physician and physician, any non specified person and any non specified person.

### APPLICATION EXAMPLE 2

One favourable example of an application of the here disclosed method for signing, encrypting and authentication is electronic payment with digital phones (wired and wireless) or bluetooth devices, further referred to as communication device. Here the user, having a communication device has agreed and exchanged with his credit institute (bank, credit card company, credit union, etc.) a private key. The user has an encryption algorithm according to the here-disclosed inventive method stored on his communication device. The algorithm can be stored hardwired (burned in a microchip) or as software on the communication device. If the user wants to transfer finds from his account at the credit institute to an other account, e.g. to purchase goods in a store, he calls with the communication device his credit institute and accesses his account by being authentication by his encrypted private key. All necessary information to perform the electronic money transfer is then transmitted in an encoded form.

### APPLICATION EXAMPLE 3

In another embodiment of the invention the method is used to safely store confidential information on a public accessible computer.

### LIST OF MARKERS

11 Integer Engine Device
21 Byte Converter Device
31 Byte Packer Device
32 Integer Engine Device
33 Integer Engine Device
34 Byte Converter Device
35 Integer Engine Device
41 Chaos Generator Device
42 Byte Packer Device
43 Integer Engine Device
44 Integer Engine Device
51 Chaotic Bytes Encoder Device
52 Byte Packer Device
53 Chaos Generator Device
61 Chaotic String Encoder Device
62 Chaotic Bytes Encoder Device
71 Chaotic String Encoder Device
81 Chaos Encrypter and Signer Device
82 Chaotic String Encoder Device
83 Integer Engine Device
84 Chaos Generator Device
131 Key Pair Pool Provider Device
132 Chaotic String Encoder Device
141 Initial Key Provider Device
142 Key Pair Pool Provider Device
143 Chaotic String Encoder Device
151 Chaos Decrypter and Verifyer Device
152 Initial Key Provider Device
153 Integer Engine Device
154 Chaos Generator Device
161 Connection Terminator
171 Web Browser Machine
172 Client Proxy Machine
173 Client Machine
174 Network Transmission Channel
175 Server Machine
176 Server Proxy Machine
177 HTTP Server Machine
178 Chaotic String Encoder Device
179 Key Pair Pool Provider Device
1710 Connection Terminator
1711 Chaotic String Encoder Device
1712 Chaotic String Encoder Device
1713 Connection Terminator
1714 Chaotic String Encoder Device
1715 Chaotic String Encoder Device
1716 Chaos Encryptor and Signer Device
1717 Chaos Decryptor and Verifyer Device
1718 Connection Terminator
1719 Chaos Encryptor and Signer Device
1720 Chaos Decryptor and Verifyer Device
1721 Connection Terminator
1722 Chaos Encryptor and Signer Device
1723 Chaos Decryptor and Verifyer Device
1724 Connection Terminator
1725 Connection Terminator

### LIST OF ABBREVIATIONS

A Number system radix, for instance A=16 for the hexadecimal number system
AES Advanced Encryption Standard
API Application Program Interface
ASCII American Standard Code for Information Interchange
B_{C} Block of cipher bytes
B_{D} Block of data bytes
B_{K} Block of key bytes
CHADV Chaos Decryptor and Verifyer
CHAES Chaos Encryptor and Signer
CHADSEA Chaotic Digital Signature, Encryption and Authentication
CPU Central Processing Unit
DES Data Encryption Standard
DSS Digital Signature Standard
ECDSA Elliptic Curve Digital Signature Algorithm
ElGamal Encryption technique named after its inventor Tahel ElGamal
F Combining function F=f(B_{D}, B_{K}) which fulfils B_{D}=F(F(B_{D}, B_{K}), B_{K}), and yields a block ofcipher bytes from a block of data bytes and a block of key bytes
FFT Fast Fourier Transform
FTP File Transfer Protocol
G Byte packing function G=f(B_{D}) yielding a polynomial integer number P from a block of data bytes
GNU Gnu is Not Unix, Project of the Free Software Foundation
GnuPG GNU Privacy Guard, Encryption tool
H Combining function H=f(P₁, P₁) yielding a polynomial integer number by combining a polynomial integer number, P₁, with an other polynomial integer number, P₂
HTTP HyperText Transfer Protocol
IC Integrated Circuit
IDEA International Data Encryption Algorithm
J Number of data byte or cipher byte blocks of a document
KB KiloByte (=1024 bytes)
NIST National Institute of Standards and Technology
P Polynomial integer number
P₀ Polynomial integer number and starting value for the chaos generator
P_{bp} Byte packed polynomial integer number generated with G
P_{K} Encryption key in form of a polynomial integer number
PGP Pretty Good Privacy, Encryption tool.
RSA Rivest, Shamir and Adleman Algorithm
SMTP Simple Mail Transfer Protocol
TCP Transmission Control Protocol
TCP/IP Transmission Control Protocol/internet Protocol
UDP User Datagram Protocol
URL Universal/Uniform Resource Locator
WAP Wireless Application Protocol
XOR Is the bit operator Exclusive OR
XOR-ing Applying the XOR operator onto two bits.

1. A cryptography method, wherein the encryption keys, P_{K}, are polynomial integer numbers, and wherein these encryption keys are generated by a pseudo random number generator.

2. A cryptography method according to claim 1, wherein a document is sequentially divided into at least one block of data bytes, B_{D}, and each block of data bytes is combined with the bytes, B_{K}, of a said encryption key, P_{K}, by a combining function F=f(B_{D}, B_{K}) such that the application of the said combining function yields the encrypted cipher bytes, B_{C}=F(B_{D}, B_{K}), and wherein said combining function F has to fulfil the condition B_{D}=F(F(B_{D}, B_{K}), B_{K}).

3. A cryptography method according to claim 1, wherein the said random number generator is a chaos generator.

4. A cryptography method according to claims 1 and 3, wherein the said chaos generator is based on the recursive Logistic equation
xₙ₊₁=r·xₙ(1−xₙ); xₙ ∈ [0,1]∀n ∈ {0,1, . . . , ∞}; 0≦r≦4
wherein r is the bifurcation factor.

5. A cryptography method according to claim 1, wherein the polynomial integer numbers are part of the set
$$P = sign \cdot {\sum }_{m = 0}^{M} ( {a}_{m} \cdot {A}^{b \cdot m} )$$
$$A ∈ [ 2 , {2}^{i} ]$$
$${a}_{m} ∈ [ 0 , {A}^{b} - 1 ]$$
$$b \leq int ( \frac{i \cdot log 2}{2 \cdot log A} )$$
$$M ∈ [ 1 , {2}^{i - 2} ]$$
$$sign ∈ \{ + 1 , - 1 \}$$
where P is a polynomial integer number, sign is the signum of P, M is any desired polynomial order, aₘ are the polynomial coefficients, A is any desired number system radix, i is the number of bits available for the implementing machine internal representation of an unsigned integer value, b determines the maximum integer value of each polynomial coefficient and is itself determined by the implementing machine and by the number system radix, A.

6. A chaos generator according to claim 4 and calculating polynomial integer numbers P according to claim 5, in which the form of the Logistic equation is transferred onto the integer polynomial number space and is a member of the group consisting of
$$\begin{matrix}a . \\ {P}_{n + 1} = \frac{R \cdot {P}_{n} ( {A}^{k} - {P}_{n} )}{{A}^{k + d}} ; {P}_{n} ∈ [ 0 , {A}^{k} ] ∀ n ∈ \{ 0 , 1 , … , ∞ \} \\ R = r \cdot {A}^{d} \\ d ∈ {N}^{+} & \\ b . \\ {P}_{n + 1} = {A}^{k - 1} + R \frac{( {P}_{n} - {A}^{k - 1} ) ( {A}^{k} - {P}_{n} )}{{A}^{k - 1 + d}} ; \\ {P}_{n} ∈ [ {A}^{k - 1} , {A}^{k} ] ∀ n ∈ \{ 0 , 1 , … , ∞ \} \\ R = \frac{r \cdot {A}^{d}}{A - 1} \\ d ∈ {N}^{+} \\ & \\ c . \\ {P}_{n + 1}^{*} = \frac{R \cdot {P}_{n} ( {A}^{k} - {P}_{n} )}{{A}^{k + d}} ; {P}_{n} ∈ [ 0 , {A}^{k} ] \\ {P}_{n + 1} = \{ \begin{matrix}{P}_{n + 1}^{*} & if {P}_{n + 1}^{*} > {A}^{k - 1} \\ {A}^{k} - {P}_{n + 1}^{*} & if {P}_{n + 1}^{*} \leq {A}^{k - 1}\end{matrix} \} ; {P}_{n + 1} ∈ [ {A}^{k - 1} , {A}^{k} ] \\ R = r \cdot {A}^{d} \\ d ∈ {N}^{+} & \end{matrix}$$
and wherein A is any desired number system radix, k is any arbitrary length of the polynomial integer number, r is the bifurcation factor of the logistic equation, d is any arbitrary scaling factor, N⁺ is the set of the positive definite natural numbers, and P is a polynomial integer number according to claim 5.

7. A cryptography method according to claims 1-6, wherein the radix A of the number system is part of the subset of all natural numbers within the interval [2, 2ⁱ] where i is the number of bits available for the implementing machine internal representation of an unsigned integer value, and wherein A=256 is the radix of the byte number system, A=16 is the radix of the hexadecimal, A=10 the radix of the decimal, A=8 the radix of the octal, and A=2 the radix of the binary number system.

8. A cryptography method according to claim 2 wherein said combining function F consists of the bitwise application of the exclusive OR (XOR) bit operator onto the said data and the respective said encryption key bytes such that the resulting cipher bytes are given by B_{C}=F(B_{D}, B_{K})=(B_{D}⊕B_{K}) where ⊕ is the symbol for the XOR operator.

9. A cryptography method according to claims 1 and 2, wherein the method is used for encrypting, decrypting, signing, and verifying a document or performing any combination of these.

10. A method for electronically encrypting an electronic document comprising a cryptography method according to claims 1-9, wherein each block of data bytes, (B_{D})ⱼ, j={1, . . . , J}, is encrypted with the bytes, (B_{K})ⱼ₋₁, of the encryption key, (P_{K})ⱼ₋₁, resulting from the chaos generator processing of the previous block of data bytes, and with said combining function F thus yielding the block of cipher bytes, (B_{C})ⱼ; wherein then the block of data bytes, (B_{D})ⱼ, are packed into a polynomial integer number with any byte packing function G=f(B_{D}) thus yielding a byte packed polynomial integer number, (P_{bp})ⱼ=G((B_{D})ⱼ); wherein then the starting value for the Logistic equation according to claim 6, the polynomial integer number P₀, is gained by any other combining function H=f(P_{K}, P_{bp}) applied onto (P_{K})ⱼ and (P_{bp})ⱼ such that (P₀)ⱼ=H((P_{K})ⱼ, (P_{bp})ⱼ); wherein then the Logistic equation is iterated certain N times with a certain bifurcation factor R thus yielding a polynomial integer number which is then the encryption key, (P_{K})ⱼ, for the encryption of the next block of data bytes, (B_{D})ⱼ₊₁; and wherein this procedure is repeated until all blocks, J, of data bytes are encrypted.

11. A method for electronically decrypting an electronic document comprising a cryptography method according to claims 1-9, wherein each block of cipher bytes, (B_{C})ⱼ, j={1, 2, . . . , J}, is decrypted with the bytes, (B_{K})ⱼ₋₁, of the encryption key, (P_{K})ⱼ₋₁, resulting from the chaos generator processing of the previous block of data bytes, and with said combining function F thus yielding the block of data bytes, (B_{D})ⱼ; wherein then the block of data bytes, (B_{D})ⱼ, are packed into a polynomial integer number with the same byte packing function G=f(B_{D}) as used for encryption according to claim 10 thus yielding a byte packed polynomial integer number, (P_{bp})ⱼ=G((B_{D})ⱼ); wherein then the starting value for the Logistic equation according to claim 6, the polynomial integer number P₀, is gained by the same other combining function H=f(P_{K}, P_{bp}) as used for encryption according to claim 10 and applied onto (P_{K})ⱼ and (P_{bp})ⱼ such that (P₀)ⱼ=H((P_{K})ⱼ, (P_{bp})ⱼ); wherein then the Logistic equation is iterated with the same certain N times and with the same certain bifurcation factor R as used for encryption according to claim 10 thus yielding a polynomial integer number which is then the encryption key, (P_{K})ⱼ, for the decryption of the next block of cipher bytes, (B_{C})ⱼ₊₁; and wherein this procedure is repeated until all blocks, J, of cipher bytes are decrypted.

12. A method for electronically signing an electronic document comprising a cryptography method according to claims 1-9 and comprising an encryption method according to claim 10, and wherein the very last iteration of the Logistic equation for the very last block of data bytes yields a very last encryption key, (P_{K})_{J}, which is a polynomial integer number; and wherein this very last polynomial integer number, (P_{K})_{J}, is used as the signature of the document.

13. A method for electronically verifying the signature of a signed and encrypted electronic document comprising a cryptography method according to claims 1-9 and comprising a decryption method according to claim 11, and wherein the very last iteration of the Logistic equation for the very last block of decrypted data bytes yields a very last encryption key, (P_{K})_{J}, which is a polynomial integer number; and wherein this very last polynomial integer number, (P_{K})_{J}, is compared against the signature of the document according to claim 12.

14. A method for encrypting, decrypting, signing and verifying an electronic document according to claims 10-13, wherein the said certain number of iteration steps, N, and the said certain bifurcation factor R may be different for each data block and wherein this variation may be in any way functional dependent on the encryption key and/or the bytes of the previous data block, or on any other information gained or generated by any means.

15. A method for encrypting, decrypting, signing and verifying an electronic document according to claims 10-13, wherein the very first initial encryption key, (P_{K})₀, is gained from the secret private key, PK, and from any other information, OI, by merging the contents of PK and OI into a new information, NI; and where the bytes of NI are processed with the encryption method according to claim 10 but without generating any cipher bytes, and wherein the resulting signature of this said new information according to claim 12 is then used as the first initial encryption key, (P_{K})₀; and wherein starting the chaos generator according to claim 6 for the very first time is done with a starting value, P₀, gained by any means of packing all or a subset of bytes of NI into a polynomial integer number.

16. A method for encrypting, decrypting, signing and verifying an electronic document according to claims 10-13, wherein the said byte packing function G generates a polynomial integer number according to claim 5, wherein the byte values are transformed and ordered into a polynomial integer number by any means appropriate for the number system radix, A, actually used and appropriate for the desired length of the polynomial integer number, k, according to claim 6.

17. A method for encrypting, decrypting, signing and verifying an electronic document according to claims 10-13, wherein the said other combining function H generates a polynomial integer number of length k from two other polynomial integer numbers of the same length k.

18. A method for encrypting, decrypting, signing and verifying an electronic document according to claim 17, wherein the said other combining function H is a member of the group consisting of the arithmetic mean function, any other weighted interpolation function or the bitwise application of the exclusive OR (XOR) bit operator.

19. A method for encrypting, decrypting, signing and verifying an electronic document according to claim 15, wherein the said other information, OI, consist of a public key-ID, or the name of the encrypting entity, or a unique timestamp, or any encryption flags giving information about potential prior data compression and polynomial integer number length, k, actually used, or any combination of the before said.

20. A method for encrypting, decrypting, signing and verifying an electronic document according to claim 19, wherein the said public key-ID is any information suitable to detect the secret private key to use for decryption by the decrypting entity and without giving any information about the structure or content of the secret private key itself.

21. A method for encrypting, decrypting, signing and verifying an electronic document according to claim 20, wherein the said public key-ID is generated from the secret private key by processing the bytes of the secret private key in the same way as the new information, NI, according to claim 15, and then using the said first initial encryption key, (P_{K})₀, according to claim 15 as the public key-ID.

22. A method for encrypting, decrypting, signing and verifying an electronic document according to claim 19, wherein the said unique timestamp consists of any byte sequence appropriate to be unique with respect to all encryptions to be performed.

23. A method for encrypting, decrypting, signing and verifying an electronic document according to claim 19, wherein the said unique timestamp is any representation of the actual date and time of encryption.

24. A cryptography method according to claims 1 and 2, comprising that said document is transmitted between a sending entity and a receiving entity, and comprising a signature according to claim 12, and comprising a document header, wherein said document header consists of the other information OI, according to claims 19-23.

25. A cryptography method according to claim 24, wherein the said document header is inserted in front, in the back, in a defined position within, or in any combination hereof of the document or any document block.

26. A cryptography method according to claim 24, wherein the said signature is inserted in front, in the back, in a defined position within, or in any combination hereof of the document or any document block.

27. A cryptography method according to claim 24, wherein the transmission is done over any transmission channel and independent on its physical implementation, and wherein the transmission is done using any transmission protocol.

28. A cryptography method according to claim 24, wherein the document is exchanged by a pair of entities, in which the pair of entities is a member of the group consisting of attorney and client, attorney and attorney, accountants and client, accountant and accountant, any type of consultant and client, any type of consultant and any type of consultant, government agency and client of government agency, government agency and government agency, bank and customer, bank and bank, for profit businesses and customer, for profit businesses and for profit businesses, any sales organization and sales person out in the field, hospital and patient, hospital and hospital, physician and patient, physician and physician, any non specified person and any non specified person

29. A cryptography method according to claims 1 and 2, wherein the encrypted document is stored on any storing device.

30. A cryptography method according to claim 1, wherein the method is used to authenticate a sending entity by a receiving entity; comprising that a public key-ID according to claims 20 and 21 is sent from a sending entity to a receiving entity according to claim 27; wherein then the receiving entity detects the respective secret private key to be used for the further communication; wherein then the receiving entity generates a timestamp according to claims 22 and 23, processes this timestamp and the secret private key with the chaos generator as the said merged new information, NI, according to claim 15 where the other information, OI according to claim 15, now consists of the timestamp, and then yields a check value, CV, which is the said resulting signature according to claim 15; wherein then the receiving entity transmits the timestamp to the sending entity; wherein then the sending entity generates a resulting signature from the secret private key and this timestamp in the same way as the receiving entity has generated CV, and sends this resulting signature as a proof value, PV, to the receiving entity; wherein then the receiving entity compares the received proof value, PV, with the calculated check value, CV; wherein then the receiving entity decides that the sending entity is the entity it pretends to be when CV is equal to PV, and decides that the sending entity is not the entity it pretends to be when CV is not equal to PV.

31. A method according claims 1-30 in which some or all components are implemented by means of any software, any hardware, or any combination hereof in a machine.
